(19) United States
(12) Patent Application Publication
(10) Pub. No.: US 2025/0392426 A1
(43) Pub. Date: Dec. 25, 2025

(54) REFERENCE SIGNAL PATTERN ASSOCIATION FOR CHANNEL ESTIMATION

(71) Applicant: QUALCOMM Incorporated, San Diego, CA (US)

(72) Inventors: Rui HU, Beijing (CN); Chenxi HAO, Beijing (CN); Chao WEI, Beijing (CN); Hao XU, Beijing (CN); Taesang YOO, San Diego, CA (US); Wei XI, Beijing (CN)

(21) Appl. No.: 18/879,658

(22) PCT Filed: Sep. 2, 2022
(86) PCT No.: PCT/CN2022/116687

§ 371 Date: Dec. 27, 2024

(51) Int. Cl. H04L 5/00; H04W 24/10

(52) U.S. Cl. CPC H04L 5/005; H04W 24/10

(57) ABSTRACT

Methods, systems, and devices for wireless communications are described. A user equipment (UE) may receive a control signal configuring a low-density pattern for channel state information (CSI) reference signal (RS) reception for a set of multiple antenna ports. The low-density pattern may indicate a subset of the set of multiple antenna ports for the CSI-RS reception via one or more resource blocks (RBs). The UE may receive a set of multiple CSI-RSs that is based on the low-density pattern. In some cases, the UE, or some other training device, may train an artificial neural network to process the CSI-RSs according to the low-density pattern. The artificial neural network may be an example of a generalized neural network or a neural network specific to one or more low-density patterns. The UE may transmit a CSI report based on processing the CSI-RSs according to the low-density pattern.

### CROSS REFERENCE

The present Application is a 371 national stage filing of International PCT Application No. PCT/CN2022/116687 by HU et al. entitled “REFERENCE SIGNAL PATTERN ASSOCIATION FOR CHANNEL ESTIMATION,” filed Sep. 2, 2022, which is assigned to the assignee hereof, and which is expressly incorporated by reference in its entirety herein.

### INTRODUCTION

The following relates to wireless communications, including managing resources for channel estimation.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

An apparatus for wireless communications at a UE is described. The apparatus may include a processor and memory coupled with the processor. The processor may be configured to receive, from a network entity, a control signal that configures a low-density pattern for channel state information reference signal reception for a set of multiple antenna ports, where the low-density pattern indicates a subset of the set of multiple antenna ports for the channel state information reference signal reception via one or more resource blocks. In some examples, the processor may be configured to receive, from the network entity, a set of multiple channel state information reference signals in accordance with the low-density pattern. In some examples, the processor may be configured to transmit, to the network entity, a channel state information report based on the set of multiple channel state information reference signals.

A method for wireless communications at a UE is described. The method may include receiving, from a network entity, a control signal configuring a low-density pattern for channel state information reference signal reception for a set of multiple antenna ports, where the low-density pattern indicates a subset of the set of multiple antenna ports for the channel state information reference signal reception via one or more resource blocks. In some examples, the method may include receiving, from the network entity, a set of multiple channel state information reference signals in accordance with the low-density pattern. In some examples, the method may further include transmitting, to the network entity, a channel state information report based on the set of multiple channel state information reference signals.

Another apparatus for wireless communications at a UE is described. The apparatus may include means for receiving, from a network entity, a control signal configuring a low-density pattern for channel state information reference signal reception for a set of multiple antenna ports, where the low-density pattern indicates a subset of the set of multiple antenna ports for the channel state information reference signal reception via one or more resource blocks. In some examples, the apparatus may include means for receiving, from the network entity, a set of multiple channel state information reference signals in accordance with the low-density pattern. In some examples, the apparatus may further include means for transmitting, to the network entity, a channel state information report based on the set of multiple channel state information reference signals.

A non-transitory computer-readable medium storing code for wireless communications at a UE is described. The code may include instructions executable by a processor to receive, from a network entity, a control signal configuring a low-density pattern for channel state information reference signal reception for a set of multiple antenna ports, where the low-density pattern indicates a subset of the set of multiple antenna ports for the channel state information reference signal reception via one or more resource blocks. In some examples, the instructions may be executable by the processor to receive, from the network entity, a set of multiple channel state information reference signals in accordance with the low-density pattern. In some examples, the instructions may further be executable by the processor to transmit, to the network entity, a channel state information report based on the set of multiple channel state information reference signals.

Some examples of the method, apparatuses, and non-transitory computer-readable medium described herein may further include operations, features, means, or instructions for determining the low-density pattern based on the control signal that indicates a mapping from the subset of the set of multiple antenna ports to the set of multiple antenna ports for the one or more resource blocks.

In some examples of the method, apparatuses, and non-transitory computer-readable medium described herein, the mapping may be specific to a resource block, may be specific to a resource block group, or may be common to a set of multiple resource blocks in a frequency band that corresponds to the channel state information reference signal reception.

Some examples of the method, apparatuses, and non-transitory computer-readable medium described herein may further include operations, features, means, or instructions for determining the low-density pattern based on the control signal that indicates a resource block muting pattern for one or more antenna ports of the set of multiple antenna ports.

In some examples of the method, apparatuses, and non-transitory computer-readable medium described herein, the resource block muting pattern may be specific to an antenna port of the set of multiple antenna ports, may be specific to a group of antenna ports of the set of multiple antenna ports, or may be common to the set of multiple antenna ports.

Some examples of the method, apparatuses, and non-transitory computer-readable medium described herein may further include operations, features, means, or instructions for determining the low-density pattern based on the control signal that indicates an antenna port muting pattern for the one or more resource blocks.

In some examples of the method, apparatuses, and non-transitory computer-readable medium described herein, the antenna port muting pattern may be specific to a resource block, may be specific to a resource block group, or may be common to a set of multiple resource blocks in a frequency band that corresponds to the channel state information reference signal reception.

Some examples of the method, apparatuses, and non-transitory computer-readable medium described herein may further include operations, features, means, or instructions for determining the low-density pattern based on the control signal that indicates a cover code that configures a set of multiple antenna port-resource block pairs to use for the channel state information reference signal reception.

Some examples of the method, apparatuses, and non-transitory computer-readable medium described herein may further include operations, features, means, or instructions for determining a channel state information measurement based on an artificial neural network and the set of multiple channel state information reference signals received in accordance with the low-density pattern, where the channel state information report includes the channel state information measurement.

Some examples of the method, apparatuses, and non-transitory computer-readable medium described herein may further include operations, features, means, or instructions for zero-padding the received set of multiple channel state information reference signals based on the low-density pattern and inputting the zero-padded received set of multiple channel state information reference signals into the artificial neural network, where the channel state information measurement may be determined based on an output of the artificial neural network.

Some examples of the method, apparatuses, and non-transitory computer-readable medium described herein may further include operations, features, means, or instructions for training the artificial neural network based on the low-density pattern.

In some examples of the method, apparatuses, and non-transitory computer-readable medium described herein, the control signal includes a bit map that indicates the low-density pattern for the channel state information reference signal reception.

In some examples of the method, apparatuses, and non-transitory computer-readable medium described herein, the control signal indicates a first quantity of the subset of the set of multiple antenna ports and a second quantity of the set of multiple antenna ports, and the method, apparatuses, and non-transitory computer-readable medium may include further operations, features, means, or instructions for determining the low-density pattern for the channel state information reference signal reception based on the first quantity, the second quantity, and a rule, a lookup table, or both for mapping from the first quantity and the second quantity to the low-density pattern.

Some examples of the method, apparatuses, and non-transitory computer-readable medium described herein may further include operations, features, means, or instructions for storing a set of multiple low-density patterns, where the control signal includes an index value that indicates the low-density pattern from the set of multiple low-density patterns.

In some examples of the method, apparatuses, and non-transitory computer-readable medium described herein, the control signal further includes assistance information that indicates an antenna configuration corresponding to the set of multiple antenna ports, a channel type, environmental information, transmission correlation information, or a combination thereof, and the channel state information report may be further based on the assistance information.

An apparatus for wireless communications at a network entity is described. The apparatus may include a processor and memory coupled with the processor. The processor may be configured to output a control signal that configures a low-density pattern for channel state information reference signal reception at a UE for a set of multiple antenna ports, where the low-density pattern indicates a subset of the set of multiple antenna ports for the channel state information reference signal reception via one or more resource blocks. In some examples, the processor may be configured to output a set of multiple channel state information reference signals in accordance with the low-density pattern. In some examples, the processor may be configured to obtain a channel state information report based on the set of multiple channel state information reference signals.

A method for wireless communications at a network entity is described. The method may include outputting a control signal configuring a low-density pattern for channel state information reference signal reception at a UE for a set of multiple antenna ports, where the low-density pattern indicates a subset of the set of multiple antenna ports for the channel state information reference signal reception via one or more resource blocks. In some examples, the method may include outputting a set of multiple channel state information reference signals in accordance with the low-density pattern. In some examples, the method may further include obtaining a channel state information report based on the set of multiple channel state information reference signals.

Another apparatus for wireless communications at a network entity is described. The apparatus may include means for outputting a control signal configuring a low-density pattern for channel state information reference signal reception at a UE for a set of multiple antenna ports, where the low-density pattern indicates a subset of the set of multiple antenna ports for the channel state information reference signal reception via one or more resource blocks. In some example, the apparatus may include means for outputting a set of multiple channel state information reference signals in accordance with the low-density pattern. In some examples, the apparatus may further include means for obtaining a channel state information report based on the set of multiple channel state information reference signals.

A non-transitory computer-readable medium storing code for wireless communications at a network entity is described. The code may include instructions executable by a processor to output a control signal configuring a low-density pattern for channel state information reference signal reception at a UE for a set of multiple antenna ports, where the low-density pattern indicates a subset of the set of multiple antenna ports for the channel state information reference signal reception via one or more resource blocks. In some examples, the instructions may be executable by the processor to output a set of multiple channel state information reference signals in accordance with the low-density pattern. In some examples, the instructions may further be executable by the processor to obtain a channel state information report based on the set of multiple channel state information reference signals.

In some examples of the method, apparatuses, and non-transitory computer-readable medium described herein, the control signal includes a bit map that indicates the low-density pattern for the channel state information reference signal reception.

In some examples of the method, apparatuses, and non-transitory computer-readable medium described herein, the control signal includes a first control signal and indicates a first quantity of the subset of the set of multiple antenna ports and a second quantity of the set of multiple antenna ports, and the method, apparatuses, and non-transitory computer-readable medium may include further operations, features, means, or instructions for outputting a second control signal configuring a rule, a lookup table, or both for mapping from a value pair of the first quantity of the subset of the set of multiple antenna ports and the second quantity of the set of multiple antenna ports to the low-density pattern.

Some examples of the method, apparatuses, and non-transitory computer-readable medium described herein may further include operations, features, means, or instructions for storing a set of multiple low-density patterns, where the control signal includes an index value that indicates the low-density pattern from the set of multiple low-density patterns.

In some examples of the method, apparatuses, and non-transitory computer-readable medium described herein, the control signal further includes assistance information that indicates an antenna configuration corresponding to the set of multiple antenna ports, a channel type, environmental information, transmission correlation information, or a combination thereof, and the channel state information report may be further based on the assistance information.

An apparatus for wireless communications at a device is described. The apparatus may include a processor and memory coupled with the processor. The processor may be configured to obtain a set of multiple channel state information reference signals for a set of multiple antenna ports and a set of multiple resource blocks. In some examples, the processor may be configured to determine a low-density pattern for an artificial neural network training procedure. In some examples, the processor may be configured to train a generalized artificial neural network based on a subset of the set of multiple channel state information reference signals in accordance with the determined low-density pattern, where the determined low-density pattern indicates a subset of the set of multiple antenna ports for one or more resource blocks of the set of multiple resource blocks. In some examples, the processor may be configured to output the trained generalized artificial neural network.

A method for wireless communications at a device is described. The method may include obtaining a set of multiple channel state information reference signals for a set of multiple antenna ports and a set of multiple resource blocks. In some examples, the method may include determining a low-density pattern for an artificial neural network training procedure. In some examples, the method may further include training a generalized artificial neural network based on a subset of the set of multiple channel state information reference signals in accordance with the determined low-density pattern, where the determined low-density pattern indicates a subset of the set of multiple antenna ports for one or more resource blocks of the set of multiple resource blocks. In some examples, the method may further include outputting the trained generalized artificial neural network.

Another apparatus for wireless communications at a device is described. The apparatus may include means for obtaining a set of multiple channel state information reference signals for a set of multiple antenna ports and a set of multiple resource blocks. In some examples, the apparatus may include means for determining a low-density pattern for an artificial neural network training procedure. In some examples, the apparatus may further include means for training a generalized artificial neural network based on a subset of the set of multiple channel state information reference signals in accordance with the determined low-density pattern, where the determined low-density pattern indicates a subset of the set of multiple antenna ports for one or more resource blocks of the set of multiple resource blocks. In some examples, the apparatus may further include means for outputting the trained generalized artificial neural network.

A non-transitory computer-readable medium storing code for wireless communications at a device is described. The code may include instructions executable by a processor to obtain a set of multiple channel state information reference signals for a set of multiple antenna ports and a set of multiple resource blocks. In some examples, the instructions may be executable by the processor to determine a low-density pattern for an artificial neural network training procedure. In some examples, the instructions may further be executable by the processor to train a generalized artificial neural network based on a subset of the set of multiple channel state information reference signals in accordance with the determined low-density pattern, where the determined low-density pattern indicates a subset of the set of multiple antenna ports for one or more resource blocks of the set of multiple resource blocks. In some examples, the instructions may further be executable by the processor to output the trained generalized artificial neural network.

Some examples of the method, apparatuses, and non-transitory computer-readable medium described herein may further include operations, features, means, or instructions for determining one or more additional low-density patterns for the artificial neural network training procedure and further training the generalized artificial neural network based on the one or more additional low-density patterns.

Some examples of the method, apparatuses, and non-transitory computer-readable medium described herein may further include operations, features, means, or instructions for randomly selecting one or more low-density patterns, where the low-density pattern may be determined based on the random selection.

In some examples of the method, apparatuses, and non-transitory computer-readable medium described herein, the determined low-density pattern indicates a random selection of the subset of the set of multiple antenna ports for each resource block of the set of multiple resource blocks.

In some examples of the method, apparatuses, and non-transitory computer-readable medium described herein, the determined low-density pattern indicates a random selection of the subset of the set of multiple antenna ports for a first set of resource blocks of the set of multiple resource blocks, and a selection of the subset of the set of multiple antenna ports for a second set of resource blocks of the set of multiple resource blocks may be based on the random selection of the subset of the set of multiple antenna ports for the first set of resource blocks.

An apparatus for wireless communications at a device is described. The apparatus may include a processor and memory coupled with the processor. The processor may be configured to obtain a set of multiple channel state information reference signals for a set of multiple antenna ports and a set of multiple resource blocks. In some examples, the processor may be configured to train an artificial neural network specific to one or more low-density patterns configured at the device based on a subset of the set of multiple channel state information reference signals in accordance with the one or more low-density patterns, where a low-density pattern of the one or more low-density patterns indicates a subset of the set of multiple antenna ports for one or more resource blocks of the set of multiple resource blocks. In some examples, the processor may be configured to output the trained artificial neural network.

A method for wireless communications at a device is described. The method may include obtaining a set of multiple channel state information reference signals for a set of multiple antenna ports and a set of multiple resource blocks. In some examples, the method may include training an artificial neural network specific to one or more low-density patterns configured at the device based on a subset of the set of multiple channel state information reference signals in accordance with the one or more low-density patterns, where a low-density pattern of the one or more low-density patterns indicates a subset of the set of multiple antenna ports for one or more resource blocks of the set of multiple resource blocks. In some examples, the method may further include outputting the trained artificial neural network.

Another apparatus for wireless communications at a device is described. The apparatus may include means for obtaining a set of multiple channel state information reference signals for a set of multiple antenna ports and a set of multiple resource blocks. In some examples, the apparatus may include means for training an artificial neural network specific to one or more low-density patterns configured at the device based on a subset of the set of multiple channel state information reference signals in accordance with the one or more low-density patterns, where a low-density pattern of the one or more low-density patterns indicates a subset of the set of multiple antenna ports for one or more resource blocks of the set of multiple resource blocks. In some examples, the apparatus may further include means for outputting the trained artificial neural network.

A non-transitory computer-readable medium storing code for wireless communications at a device is described. The code may include instructions executable by a processor to obtain a set of multiple channel state information reference signals for a set of multiple antenna ports and a set of multiple resource blocks. In some examples, the instructions may be executable by the processor to train an artificial neural network specific to one or more low-density patterns configured at the device based on a subset of the set of multiple channel state information reference signals in accordance with the one or more low-density patterns, where a low-density pattern of the one or more low-density patterns indicates a subset of the set of multiple antenna ports for one or more resource blocks of the set of multiple resource blocks. In some examples, the instructions may further be executable by the processor to output the trained artificial neural network.

Some examples of the method, apparatuses, and non-transitory computer-readable medium described herein may further include operations, features, means, or instructions for obtaining a configuration of the one or more low-density patterns, where the artificial neural network may be trained based on the configuration.

Some examples of the method, apparatuses, and non-transitory computer-readable medium described herein may further include operations, features, means, or instructions for storing the one or more low-density patterns at the device, where the artificial neural network may be trained based on the stored one or more low-density patterns.

In some examples of the method, apparatuses, and non-transitory computer-readable medium described herein, the artificial neural network may be specific to a low-density pattern, and the method, apparatuses, and non-transitory computer-readable medium may include further operations, features, means, or instructions for training one or more additional artificial neural networks specific to one or more additional low density patterns configured at the device and outputting the one or more additional trained artificial neural networks.

In some examples of the method, apparatuses, and non-transitory computer readable medium described herein, the outputting the trained artificial neural network may include operations, features, means, or instructions for outputting the trained artificial neural network with an indication that the trained artificial neural network may be specific to the one or more low-density patterns.

### BRIEF DESCRIPTION OF THE DRAWINGS

FIG. 1 illustrates an example of a wireless communications system that supports reference signal pattern association for channel estimation in accordance with one or more aspects of the present disclosure.

FIG. 2 illustrates an example of a network architecture that supports reference signal pattern association for channel estimation in accordance with one or more aspects of the present disclosure.

FIG. 3 illustrates an example of a wireless communications system that supports reference signal pattern association for channel estimation in accordance with one or more aspects of the present disclosure.

FIG. 4 illustrates an example of a rule-based association for a low-density pattern that supports reference signal pattern association for channel estimation in accordance with one or more aspects of the present disclosure.

FIG. 5 illustrates an example of low-density patterns that support reference signal pattern association for channel estimation in accordance with one or more aspects of the present disclosure.

FIG. 6 illustrates an example of a channel estimation procedure that supports reference signal pattern association for channel estimation in accordance with one or more aspects of the present disclosure.

FIG. 7 illustrates an example of a machine learning process that supports reference signal pattern association for channel estimation in accordance with one or more aspects of the present disclosure.

FIG. 8 illustrates an example of a process flow that supports reference signal pattern association for channel estimation in accordance with one or more aspects of the present disclosure.

FIGS. 9 and 10 show block diagrams of devices that support reference signal pattern association for channel estimation in accordance with one or more aspects of the present disclosure.

FIG. 11 shows a block diagram of a communications manager that supports reference signal pattern association for channel estimation in accordance with one or more aspects of the present disclosure.

FIG. 12 shows a diagram of a system including a device that supports reference signal pattern association for channel estimation in accordance with one or more aspects of the present disclosure.

FIGS. 13 and 14 show block diagrams of devices that support reference signal pattern association for channel estimation in accordance with one or more aspects of the present disclosure.

FIG. 15 shows a block diagram of a communications manager that supports reference signal pattern association for channel estimation in accordance with one or more aspects of the present disclosure.

FIG. 16 shows a diagram of a system including a device that supports reference signal pattern association for channel estimation in accordance with one or more aspects of the present disclosure.

FIGS. 17 through 20 show flowcharts illustrating methods that support reference signal pattern association for channel estimation in accordance with one or more aspects of the present disclosure.

### DETAILED DESCRIPTION

In some wireless communications systems, a network entity (e.g., a base station, a radio unit (RU)) may transmit a set of channel state information (CSI) reference signals (RSs) to support channel estimation by a UE. If the network entity includes multiple antenna ports, the network entity may transmit CSI-RSs based on a “high-density” or “full-density” pattern, where each antenna port is configured to transmit a CSI-RS via each frequency resource (e.g., each resource block (RB)) within a frequency range (e.g., a channel bandwidth, a sub-band, a bandwidth part (BWP)). The UE may receive the CSI-RSs and may perform channel estimation using the received CSI-RSs. Using such a high-density pattern for CSI-RSs may support relatively granular CSI measurements by the UE. However, communicating the CSI-RSs using a subset of the antenna ports, a subset of the frequency resources, or both, instead of communicating the CSI-RSs using each antenna port via each frequency resource, may improve a channel overhead associated with the CSI-RSs, may improve processing overheads associated with transmitting the CSI-RSs at the network entity and associated with receiving and processing the CSI-RSs at the UE, or some combination thereof.

As described herein, a network entity and a UE may implement a “low-density” pattern for CSI-RS communication to reduce a quantity of CSI-RSs used for channel estimation. A low-density pattern may indicate a subset of the total quantity of antenna ports for CSI-RS communication (e.g., transmission by the network entity and reception by the UE), a subset of the total quantity of RBs in a frequency range for CSI-RS communication, or both. The low-density pattern may be different from a high-density pattern, which may indicate the total quantity of antenna ports and the total quantity of RBs in the frequency range for CSI-RS communication. Accordingly, transmitting CSI-RSs in accordance with a low-density pattern may involve the network entity transmitting a subset of CSI-RSs, as compared to transmitting a full set of CSI-RSs corresponding to each antenna port and each RB for a high-density pattern. The network entity may transmit, to the UE, a control signal configuring the low-density pattern for CSI-RS reception at the UE. The network entity may additionally transmit a set of multiple CSI-RSs in accordance with the low-density pattern. The UE may determine the low-density pattern based on the control signal and may use the low-density pattern to receive and process the CSI-RSs transmitted by the network entity. The UE may transmit, to the network entity, a CSI report including channel estimation parameters or other CSI measurements determined based on processing the CSI-RSs. In some examples, the UE may use an artificial neural network, which in some cases may be referred to simply as a neural network, to process the CSI-RSs for channel estimation. In some cases, the UE may train a generalized neural network, for example, to process CSI-RSs transmitted according to any low-density pattern selected by the network entity. In some other cases, the UE may train one or more neural networks specific to one or more low-density patterns, such as a set of low-density patterns configured at the UE. A trained neural network may support using a subset of CSI-RSs received via a subset of antenna ports, a subset of RBs, or both for a channel to estimate the full channel (e.g., for the total set of antenna ports and the total set of RBs).

Aspects of the subject matter described herein may be implemented by a device to support improved processing complexity and improved channel overhead associated with CSI-RS communication. For example, a network entity may select to use a low-density pattern to reduce the quantity of CSI-RSs transmitted via a channel, effectively improving the channel overhead. Additionally, the network entity may improve a processing overhead at the network entity associated with generating and transmitting the CSI-RSs. Similarly, a UE may improve a processing overhead at the UE associated with receiving and processing CSI-RSs based on using the low-density pattern. For example, the UE may receive and process a reduced quantity of CSI-RSs for channel estimation. By coordinating the low-density pattern used (e.g., via control signaling by the network entity), the network entity and the UE may use a same low-density pattern and improve CSI-RS reception and processing at the UE based on the coordination. Additionally, or alternatively, the UE may train a neural network for channel estimation using a subset of CSI-RSs according to the low-density pattern. The UE may improve the accuracy of channel estimation and may improve communication reliability and performance based on using one or more neural networks trained to process low-density patterns of CSI-RSs. For example, the UE may accurately perform channel estimation for a channel using the reduced quantity of CSI-RSs transmitted via the channel.

As described herein, a low-density pattern for CSI-RS communication may indicate a set of antenna ports, a set of RBs, or both via which the CSI-RSs are communicated (e.g., transmitted by a network entity, received by a UE). The pattern may be “low-density” based on the quantity of antenna ports used for the CSI-RS transmissions being less than a total quantity of antenna ports at the network entity, the quantity of RBs used for the CSI-RS transmissions being less than a total quantity of RBs within a frequency range for the CSI-RS transmissions (e.g., a channel bandwidth, a sub-band, a bandwidth part (BWP)), or some combination thereof. In some examples, the control signal configuring the low-density pattern may indicate a muting pattern (e.g., an RB muting pattern, an antenna port muting pattern), and the UE may determine the low-density pattern based on the muting pattern. A muting pattern may be an example of an array or other bit field indicating a set of resources to refrain from using for CSI-RS communication. For example, an RB muting pattern may indicate which RBs the network entity refrains from using for the CSI-RS transmissions (e.g., for each antenna port or for a set of antenna ports), while an antenna port muting pattern may indicate which antenna ports the network entity refrains from using for the CSI-RS transmissions (e.g., for each RB or for a set of RBs). Additionally, or alternatively, the control signal configuring the low-density pattern may indicate a cover code, and the UE may determine the low-density pattern based on the cover code. A cover code may be an example of a matrix or other bit field used for multiplexing the CSI-RSs in order to transmit a subset of the CSI-RSs. For example, the cover code may include a quantity of bits equal to the total quantity of antenna ports multiplied by the total quantity of RBs, and each bit of the cover code may indicate whether a specific antenna port-RB pair is configured for CSI-RS communication.

The UE may determine a CSI measurement based on the received CSI-RSs. In some examples, a CSI measurement may be an example of a reference signal received power (RSRP) for a CSI-RS, a reference signal received quality (RSRQ) for a CSI-RS, a signal-to-noise ratio (SNR) for a CSI-RS, or any other parameters associated with measuring a strength or quality of a received CSI-RS. Additionally, or alternatively, the CSI measurement may be an example of a channel estimation parameter to include in a CSI report, such as channel quality information (CQI), a precoding matrix indicator (PMI), a layer indicator (LI), a rank indicator (RI), or any other channel estimation parameters. In some examples, the UE may use an artificial neural network to perform the channel estimation using the low-density pattern of CSI-RSs. The artificial neural network may be an example of any machine learning model trained to perform channel estimation according to one or more low-density patterns. For example, the artificial neural network may be an example of a feed forward (FF) or deep feed forward (DFF) neural network, a recurrent neural network (RNN), a long/short term memory (LSTM) neural network, or any other type of neural network trained for channel estimation. The UE may use zero-padding to pre-process received CSI-RSs before using the artificial neural network. Zero-padding may be an example of a technique to increase an array size according to a specific pattern. For example, the UE may receive the subset of CSI-RSs and may use zero-padding to map the received quantity of CSI-RSs to the correct antenna ports and RBs used for transmitting the CSI-RSs of the total set of antenna ports and the total set of RBs. The UE may use the low-density pattern to properly map the received CSI-RSs to the antenna ports and RBs, effectively increasing an array size from the quantity of received CSI-RSs to the quantity of total antenna ports multiplied by the quantity of total RBs in the frequency range. The zero-padding may involve adding zero values into specific positions of the array according to the low-density pattern (e.g., positions corresponding to antenna port and RB pairs that refrained from transmitting CSI-RSs) to obtain an array of a size that may be used for channel estimation for the full set of antenna ports and RBs (e.g., by the artificial neural network). In some examples, the artificial neural network may use the increased array size as an input size for processing the CSI-RSs.

Aspects of the disclosure are initially described in the context of wireless communications systems. Aspects of the disclosure are additionally described in the context of low-density patterns, a channel estimation procedure, a machine learning process, and a process flow. Aspects of the disclosure are further illustrated by and described with reference to apparatus diagrams, system diagrams, and flowcharts that relate to reference signal pattern association for channel estimation.

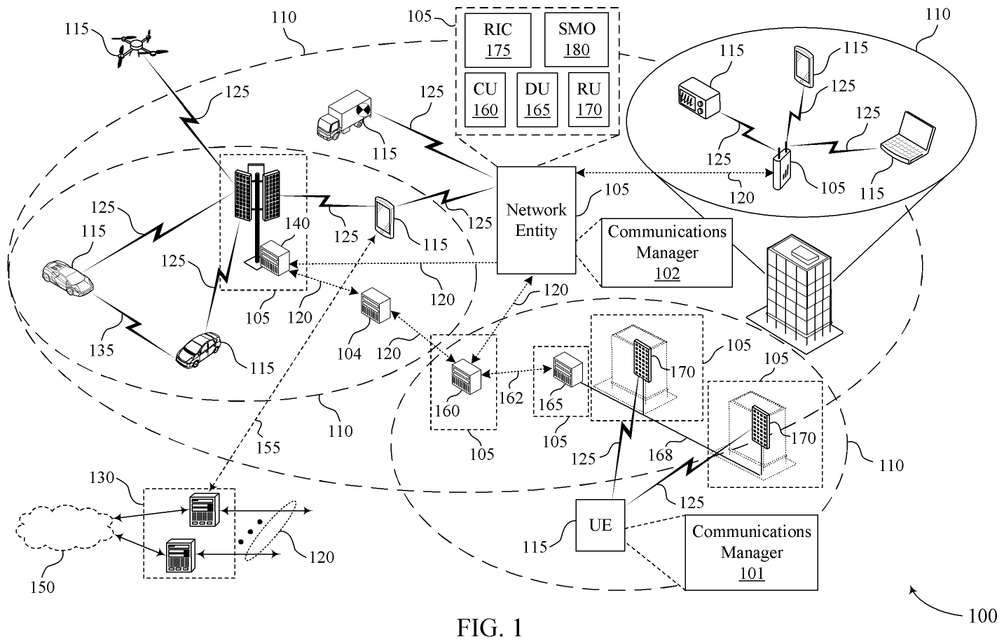

FIG. 1 illustrates an example of a wireless communications system 100 that supports reference signal pattern association for channel estimation in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE being configured to receive information from a network entity also discloses that a first network node being configured to receive information from a second network node, the first network node may refer to a first UE, a first base station, a first apparatus, a first device, a first computing system, a first one or more components, a first processing entity, or the like configured to receive the information; and the second network node may refer to a second UE, a second base station, a second apparatus, a second device, a second computing system, a second one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, an RU 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support reference signal pattern association for channel estimation as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a BWP) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and Ne may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). The region from 300 MHz to 3 GHz may be known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics or FR2 characteristics, and thus may effectively extend features of FR1 or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHZ), FR4 (52.6 GHz-114.25 GHZ), and FR5 (114.25 GHZ-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, or FR5, or may be within the EHF band.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a CSI-RS), which may be precoded or unprecoded. The UE 115 may provide feedback for beam selection, which may be a PMI or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

The wireless communications system 100 may support CSI measurements based on CSI-RS transmissions. For example, a network entity 105 (e.g., a base station 140 or other network entity 105 including multiple antenna ports) may transmit a set of multiple CSI-RSs via a channel. In some examples, the network entity 105 may transmit a CSI-RS via each frequency resource (e.g., RB) of a channel bandwidth, sub-band, or BWP using each antenna port. A UE 115 may receive the CSI-RSs and may perform channel measurements using the CSI-RSs, for example, based on an RSRP for a CSI-RS, an SNR for a CSI-RS, or any other signal metric. The UE 115 may determine one or more CSI parameters based on the channel measurements, such as CQI, a PMI, an LI, an RI, or any other CSI parameters. The UE 115 may transmit, to the network entity 105, a CSI report including the determined CSI parameters, and the UE 115 and the network entity 105 may communicate based on the information included in the CSI report.

However, using each antenna port to transmit a CSI-RS via each RB may involve a significant processing overhead (e.g., both at the network entity 105 transmitting the CSI-RSs and at the UE 115 receiving and measuring the CSI-RSs), a significant channel overhead, or both. To improve the processing overhead and channel overhead associated with CSI-RS transmission, a network entity 105 may transmit CSI-RSs (e.g., a subset of CSI-RSs) using a “low-density” pattern. The low-density pattern may configure a subset of antenna ports for transmitting CSI-RSs, a subset of RBs via which to transmit CSI-RSs, or a combination thereof. To support the low-density pattern, the network entity 105 (e.g., using a communications manager 102) may transmit a control signal configuring the low-density pattern for the UE 115, such that the UE 115 (e.g., using a communications manager 101) may use the low-density pattern to receive the transmitted CSI-RSs. Additionally, or alternatively, the UE 115 (e.g., the communications manager 101 or another component or device) may train an artificial neural network, which may simply be referred to as a neural network, to process the low-density pattern of CSI-RSs and determine channel measurements for the full channel from the transmitted subset of CSI-RSs.

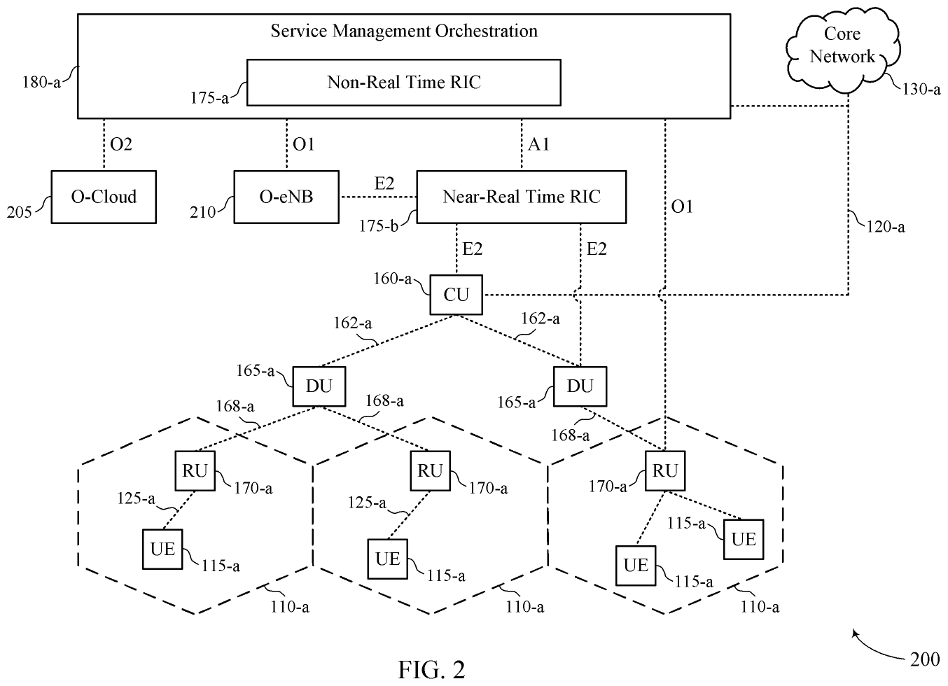

FIG. 2 illustrates an example of a network architecture 200 that supports reference signal pattern association for channel estimation in accordance with one or more aspects of the present disclosure. The network architecture 200 may be an example of a disaggregated base station architecture or a disaggregated RAN architecture. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 200 (e.g., CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an O2 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled to or communicate with (e.g., via an AI interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-eNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via 01) or via generation of RAN management policies (e.g., AI policies).

One or more network entities 105 may support CSI procedures. For example, an RU 170-a may support a set of multiple antenna ports for communicating signaling. The RU 170-a may transmit a set of multiple CSI-RSs using the antenna ports, for example, in accordance with a low-density pattern for CSI-RS transmission. Additionally, the RU 170-a may receive CSI reports from one or more UEs 115-a. The RU 170-a, a DU 165-a, a CU 160-a, or any combination thereof may process the CSI reports to determine communication parameters for communicating with one or more UEs 115-a.

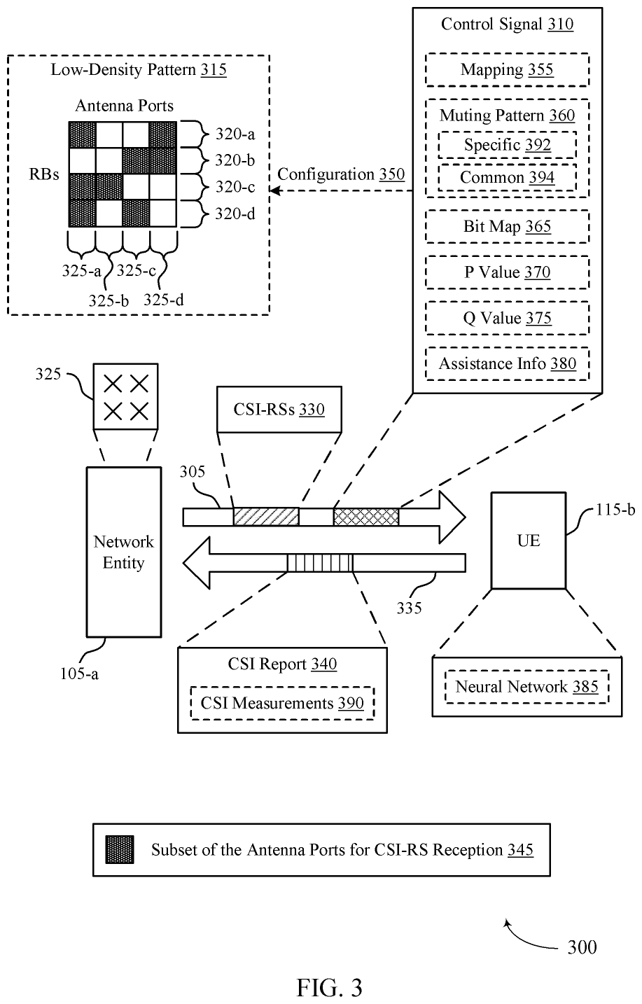

FIG. 3 illustrates an example of a wireless communications system 300 that supports reference signal pattern association for channel estimation in accordance with one or more aspects of the present disclosure. The wireless communications system 300 may be implemented by aspects of the wireless communications system 100, the network architecture 200, or both. For example, the wireless communications system 300 may include a UE 115-b and a network entity 105-a, which may be examples of a UE 115 and a network entity 105 as described with reference to FIGS. 1 and 2. The wireless communications system 300 may support the network entity 105-a configuring the UE 115-b with a low-density pattern 315 for CSI-RS reception. The UE 115-b may use the configured low-density pattern 315 to receive a set of CSI-RSs 330 and perform CSI measurements using the CSI-RSs 330.

In the wireless communications system 300, a network entity 105-a may transmit one or more CSI-RSs 330 via a channel (e.g., a downlink channel 305) to support channel estimation of the channel (e.g., the downlink channel 305). The UE 115-b may receive the CSI-RSs 330 and may measure one or more characteristics of the channel using the received CSI-RSs 330. The UE 115-b may determine one or more parameters associated with modulation, code rate, beamforming, or other CSI aspects and may report the one or more parameters to the network entity 105-a using a CSI report 340. In some cases, the UE 115-b may perform one or more CSI measurements 390 on the received CSI-RSs 330 and may include the one or more CSI measurements 390 in the CSI report 340.

In some examples, the CSI-RSs 330 may be transmitted, received, or both based on a density pattern. The density pattern may indicate which antenna ports are configured to transmit a CSI-RS via which frequency resources (e.g., RBs, RB groups, subcarriers). The network entity 105-a may use a set of multiple antenna ports 325 for communications. The antenna ports 325 may correspond (e.g., according to a one-to-one mapping or a one-to-many mapping) to physical antenna elements of an antenna array, such as a uniform planar array (UPA) (e.g., an antenna panel) or some other antenna configuration. For example, a transmission may use a specific set of logical antenna ports 325 which map to one or more physical antenna elements. The antenna array may include one or more columns of antenna elements and one or more rows of antenna elements, and each antenna element may support multiple (e.g., two) polarizations for signaling. The antenna elements of the antenna array may be further logically configured into sub-groups (e.g., sub-arrays). For example, a sub-group may span the antenna elements in a row of the antenna array. For example, a 2×2 antenna array (e.g., an antenna array with two rows and two columns of antenna elements, each antenna element supporting two polarizations) may support a set of eight antenna ports 325 and may include two sub-groups corresponding to the two rows. In some examples, the density pattern may be the same for different polarizations. For example, the density pattern may specify CSI-RS transmission for four antenna ports based on the density pattern applying across polarizations, such that the four antenna port-pattern defines CSI-RS transmission for eight total antenna ports (e.g., four with a first polarization and four with a second polarization).

In some implementations, the network entity 105-a may transmit the CSI-RSs 330 via a channel based on a “high-density” or “full-density” pattern, where each antenna port is configured to transmit a CSI-RS 330 via each frequency resource (e.g., RB) within a set of frequency resources (e.g., the channel bandwidth, a sub-band, a BWP). Such a high-density pattern may provide relatively granular CSI measurements for the channel.

However, to conserve network power, reduce signaling overhead (e.g., CSI-RS 330 overhead), or both, the network entity 105-a may use a “low-density” pattern for CSI-RS 330 transmission. The low-density pattern 315 may reduce the quantity of CSI-RSs 330 transmitted as compared to a high-density pattern, effectively reducing the processing overhead and channel overhead associated with CSI-RS transmission. The low-density pattern 315 may indicate a subset of the antenna ports 345 for the CSI-RS transmission via one or more frequency resources (e.g., RBs). A low-density pattern 315 in the spatial domain may indicate a quantity of antenna ports for transmitting CSI-RS 330 that is less than a total quantity of antenna ports configured at the network entity 105-a. For example, the low-density pattern 315 may indicate two antenna ports out of four antenna ports to use for CSI-RS transmission in the spatial domain. Additionally, or alternatively, a low-density pattern 315 in the frequency domain may indicate a quantity of RBs for transmitting CSI-RS 330 that is less than a total quantity of RBs for CSI-RS transmission (e.g., corresponding to the channel bandwidth, a sub-band, a BWP). For example, the low-density pattern 315 may indicate two RBs out of four RBs to use for CSI-RS transmission in the frequency domain.

The low-density pattern 315 may indicate two antenna ports (e.g., a subset of the antenna ports 345) for transmitting CSI-RSs 330 out of four total antenna ports (e.g., the total antenna ports 325) for each RB of a bandwidth. For example, the low-density pattern 315 may indicate CSI-RS 330 transmission using a first antenna port 325-a and a fourth antenna port 325-d via a first RB 320-a, a third antenna port 325-c and the fourth antenna port 325-d via a second RB 320-b, the first antenna port 325-a and a second antenna port 325-b via a third RB 320-c, and the first antenna port 325-a and the third antenna port 325-c via a fourth RB 320-d. In some examples, configuring CSI-RS 330 transmission for a first antenna port 325-a via a first RB 320-a may effectively configure CSI-RS 330 transmission for both polarizations corresponding to the first antenna port 325-a via the first RB 320-a. Such a low-density pattern 315 may reduce the CSI-RS overhead by approximately one half. Additionally, or alternatively, the network entity 105-a transmitting the CSI-RSs 330 according to such a low-density pattern 315, the UE 115-b receiving and processing the CSI-RSs 330 according to such a low-density pattern 315, or both may reduce CSI-RS processing overhead by approximately one half.

The network entity 105-a may transmit, via a downlink channel 305 to the UE 115-b, a control signal 310 to configure the low-density pattern 315 for CSI-RS reception at the UE 115-b for a set of multiple antenna ports 325. The low-density pattern 315 may indicate a subset of the multiple antenna ports 345 for CSI-RS reception via one or more RBs. For example, the control signal 310 may indicate an association between a set of antenna ports transmitting CSI-RSs 330 (e.g., a first set of antenna ports, such as the subset of the antenna ports 345 for CSI-RS reception) and a total set of antenna ports 325 configured at the network entity 105-a (e.g., a second set of antenna ports).

In some implementations, the association between the first set of antenna ports (e.g., the subset of the antenna ports 345) and the second set of antenna ports (e.g., the total set of antenna ports 325) may include transmit location information, which maps the first set of antenna ports to a subset of the second set of antenna ports. For example, the control signal 310 may indicate a mapping 355 from the subset of the antenna ports 345 used for CSI-RS transmission to the full set of antenna ports 325 for one or more RBs, and the UE 115-b may determine the low-density pattern 315 based on the mapping 355. In some cases, the mapping may be specific to an RB (e.g., RB-specific), or specific to an RB group (e.g., RB group-specific), or common to a set of multiple RBs in a frequency band. For example, the same subset of antenna ports may be configured for CSI-RS transmission within an RB or an RB group, or the same subset of antenna ports may be common across the RBs for CSI-RS transmission.

In some implementations, the association between the first set of antenna ports and the second set of antenna ports may be based on an RB muting pattern for each antenna port of the second set of the antenna ports (e.g., the total set of antenna ports 325). For example, the control signal 310 may include a muting pattern 360 of RBs for one or more antenna ports of the full set of antenna ports 325, and the UE 115-b may use the muting pattern 360 to determine the low-density pattern 315. In some examples, the RB muting pattern may be specific 392 to an antenna port of the total set of antenna ports 325 (e.g., port-specific), or specific 392 to a group of antenna ports of the total set of antenna ports 325 (e.g., port group-specific), or common 394 across the total set of antenna ports 325. For example, the muting pattern 360 may mute the RB 320-b for the antenna port 325-a to indicate that the network entity 105-a may transmit CSI-RSs 330 using the antenna port 325-a via the RB 320-a, the RB 320-c, and the RB 320-d (e.g., refraining from transmitting the CSI-RS using the antenna port 325-a via the RB 320-b). As illustrated in FIG. 3, the muting pattern 360 may indicate different RB muting patterns for the antenna port 325-b, the antenna port 325-c, and the antenna port 325-d.

In some implementations, the association between the first set of antenna ports and the second set of antenna ports may be based on an antenna port muting pattern for each of the RBs (e.g., within a channel bandwidth, a sub-band, a BWP). For example, the control signal 310 may include a muting pattern 360 of antenna ports for one or more RBs, and the UE 115-b may use the muting pattern 360 to determine the low-density pattern 315. In some examples, the antenna port muting pattern may be specific 392 to an RB (e.g., RB-specific), or specific 392 to an RB group (e.g., RB group-specific), or common 394 across the RBs in a frequency band. For example, the muting pattern 360 may mute the antenna port 325-b and the antenna port 325-c for the RB 320-a to indicate that the network entity 105-a may transmit CSI-RSs 330 using the antenna port 325-a and the antenna port 325-d via the RB 320-a (e.g., refraining from transmitting the CSI-RSs using the antenna port 325-b and the antenna port 325-c via the RB 320-a). As illustrated in FIG. 3, the muting pattern 360 may indicate different antenna port muting patterns for the RB 320-b, the RB 320-c, and the RB 320-d.

In some implementations, the association between the first set of antenna ports and the second set of antenna ports may include a cover code that maps each antenna port of the second set of antenna ports (e.g., the total set of antenna ports 325 at the network entity 105-a) to the resource elements (REs) of the first set of RBs (e.g., the RBs used for CSI-RS transmission). For example, the control signal 310 may include the cover code as a 2-dimensional (2D) graph or array, where a first value in the array (e.g., a “1” bit value) may configure CSI-RS transmission and a second value in the array (e.g., a “0” bit value) may indicate refraining from transmitting CSI-RS. Each value in the array may map to an antenna port-RB pair. For example, the first value in the first row of the array may be set to “1,” indicating that the first antenna port 325-a is configured to transmit CSI-RS via the first RB 320-a. The second value in the first row of the array may be set to “0,” indicating that the second antenna port 325-b is configured to refrain from transmitting CSI-RS via the first RB 320-a. The UE 115-b may use the cover code to determine the low-density pattern 315 for CSI-RS transmission (e.g., the network entity 105-a transmitting the CSI-RS may use the cover code to multiplex the CSI-RS transmission).

The network entity 105-a may configure the association between the first set of antenna ports (e.g., the subset of the antenna ports 345) and the second set of antenna ports (e.g., the total set of antenna ports 325) via any control signaling. For example, the network entity 105-a may use RRC signaling, a MAC-CE, DCI signaling, or any other control signaling to indicate a configuration 350 of the low-density pattern 315 to the UE 115-a. In some examples, the network entity 105-a may indicate parameter values associated with the low-density pattern 315. For example, the control signal 310 may include a P value 370 indicating a quantity of antenna ports in the first set of antenna ports (e.g., the subset of antenna ports 345 configured for CSI-RS transmission and reception). Additionally, or alternatively, the control signal 310 may include a Q value 375 indicating a quantity of antenna ports in the second set of antenna ports (e.g., the total set of antenna ports configured at the network entity 105-a).

In some examples, the control signal 310 may use a bit map 365 to indicate the P value 370 and the Q value 375, as well as the low-density pattern 315 for CSI-RS transmission and reception with the indicated P value 370. Additionally, or alternatively, the P value 370 and the Q value 375 may define a size for the bit map 365 to use for configuring the low-density pattern 315. For example, if the mapping is RB-common for transmit location information or an antenna port muting pattern, the bit map 365 may be of size Q with P values (e.g., “1” bit values) in the bit map 365 indicating the locations of the active P antenna ports for CSI-RS transmission. If the mapping is RB-specific for transmit location information or an antenna port muting pattern, the bit map 365 may be of size Q×N_RB, with N_RB indicating the quantity of RBs for CSI-RS transmission. The bit map 365 may include P×N_RB values (e.g., “1” bit values) indicating the locations of the active P antenna ports for each RB for CSI-RS transmission. Similarly, if the mapping is antenna port-specific for an RB muting pattern, the bit map 365 may be of size Q×N_RB and may include P×N_RB values (e.g., “1” bit values) indicating the locations of the active RBs for each antenna port. The network entity 105-a may use the bit map 365 to indicate any low-density pattern 315 supported for CSI-RS transmission.

Additionally, or alternatively, the UE 115-b may use a rule, a lookup table, or some other metric or heuristic to determine the low-density pattern 315 based on the P value 370 and the Q value 375 (e.g., the P value 370 and the Q value 375 indicated by the control signal 310). The rule, the lookup table, or the other metric or heuristic may map each {P,Q} pair to a corresponding low-density pattern 315. In some examples, the network entity 105-a may configure the UE 115-b with the rule, the lookup table, or the other metric or heuristic, for example, using control signaling (e.g., RRC signaling). In some other examples, the UE 115-b may be pre-configured with the rule, the lookup table, or the other metric or heuristic. The UE 115-b may receive the control signal 310 indicating the P value 370, the Q value 375, or both and may determine the low-density pattern 315 according to the rule, the lookup table, or the other metric or heuristic and the indicated P value 370, Q value 375, or both.

In some examples, the network entity 105 may select any low-density pattern 315 for CSI-RS transmission and may indicate the selected low-density pattern 315 via the control signal 310. In some cases, the low-density pattern 315 may be uniform, non-uniform, RB-common, RB-specific, randomized, structured-random, or any combination thereof. In some other examples, the network entity 105 may select the low-density pattern 315 from a set of low-density pattern options configured at the network entity 105-a, the UE 115-b, or both. In some such examples, the low-density patterns 315 (e.g., the pattern options) may be stored with respective index values assigned to each pattern. In some cases, the control signal 310 may indicate which low-density pattern 315 to use out of the set of multiple low-density pattern options configured at the UE 115-a using an index value. In some examples, the network entity 105-a may additionally configure the low-density pattern options for the UE 115-b using control signaling.

In some examples, the network entity 105-a may include additional assistance information 380 in the control signal 310 to configure the low-density pattern 315. The UE 115-b may use the additional assistance information 380 to improve channel estimation, determine the CSI-RS resource configuration, or both. In some cases, the additional assistance information 380 may indicate an antenna configuration at the network entity 105-a, an antenna layout at the network entity 105-a, an antenna element-to-transmit radio unit (TxRU) mapping at the network entity 105-a, analog/digital precoding information for the network entity 105-a, or any combination thereof. Additionally, or alternatively, the additional assistance information 380 may include a meta-information identifier (e.g., for metadata), and the corresponding meta-information (e.g., environmental information) may be provided via higher-layer signaling by the network entity 105-a (e.g., location management function (LMF) signaling). In some cases, the additional assistance information 380 may indicate transmit correlation to a reference signal (e.g., quasi-co-location (QCL) information to a tracking reference signal (TRS)). In some cases, the transmit correlation may be for a TRS corresponding to full antenna port transmission associated with a relatively longer periodicity and a relatively lower bandwidth.

The UE 115-b may receive the control signal 310 and determine the indicated low-density pattern 315 based on the contents of the control signal 310. The network entity 105-a may transmit a set of multiple CSI-RSs 330 via the downlink channel 305 according to the indicated low-density pattern 315. The UE 115-b may receive the CSI-RSs 330 via the subset of antenna ports 345 and may map the CSI-RSs 330 to the total set of antenna ports 325 based on the low-density pattern 315 (e.g., the association between the subset of the antenna ports 345 and the total set of antenna ports 325). In some cases, the UE 115-b may determine the channel for the total set of antenna ports 325 based on CSI measurement for the subset of the antenna ports 345 and the association between the subset of the antenna ports 345 and total set of antenna ports 325.

In some examples, the UE 115-b may use a neural network 385 to determine the channel estimation using the received subset of CSI-RSs 330 (e.g., the CSI-RSs corresponding to the subset of the antenna ports 345 for CSI-RS reception). For example, the wireless communications system 300 may utilize machine learning techniques (e.g., artificial intelligence (AI) techniques) for CSI-RS optimization (e.g., an AI-based CSI-RS optimization). In some aspects, CSI-RS optimization may enable the UE 115-b to use the low-density pattern 315 to perform a channel estimation and provide CSI feedback. In some examples, the UE 115-b may determine a CSI measurement based on the neural network 385 and receiving the set of multiple CSI-RSs 330 associated with the low-density pattern 315. In some examples, the UE 115-b may to transmit a CSI report 340 to the network entity 105-a via an uplink channel 335. The CSI report 340 may include one or more CSI measurements 390 determined by the UE 115-b.

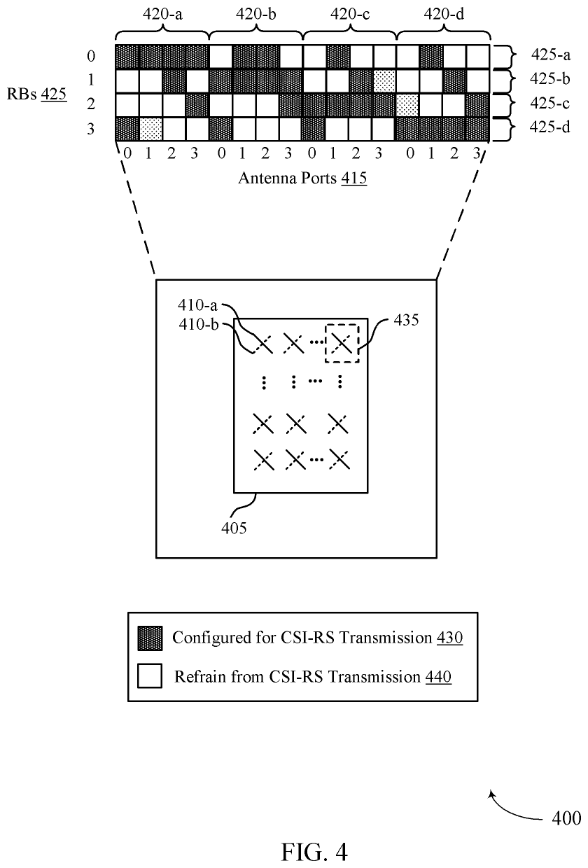

FIG. 4 illustrates an example of a rule-based association 400 for a low-density pattern that supports reference signal pattern association for channel estimation in accordance with one or more aspects of the present disclosure. The rule-based association 400 may be implemented by aspects of the wireless communications system 100, the network architecture 200, the wireless communications system 300, or any combination thereof. For example, the rule-based association 400 illustrates a possible rule for determining a low-density pattern from a P value (e.g., a subset of antenna ports for CSI-RS communication), a Q value (e.g., a total set of antenna ports at a network entity 105), or both. A UE 115, a network entity 105, or both, as described herein with reference to FIGS. 1 through 3, may use the rule-based association 400 to determine the same low-density pattern.

A network entity 105 may include an antenna array 405 (e.g., a UPA) including multiple antenna elements 435, where each antenna element 435 may further include two polarizations, a first polarization 410-a and a second polarization 410-b. In some examples, the antenna elements 435 may correspond to different antenna ports 415 for communication at the network entity 105. For example, the antenna array 405 may support N1 columns of antenna elements 435 and N2 rows of antenna elements 435, and the antenna array 405 may support N1×N2×2 antenna ports 415 for the two polarizations (e.g., a first antenna port 415 may map to a first polarization 410-a of a first antenna element 435). Each row of antenna elements 435 may be referred to as a sub-group or sub-array of antenna elements. In some examples, a low-density pattern may be the same for both polarizations. Accordingly, a bit map may indicate the low-density pattern using N1×N2 bits for each RB 425.

For example, the antenna array 405 of the network entity 105 may include four columns and four rows of antenna elements 435, such that N1=4, N2=4. Accordingly, for two polarizations, the antenna array 405 may support a Q value of 32, indicating 32 total antenna ports 415 (e.g., for the two polarizations). If the network entity 105 uses a low-density pattern to reduce the CSI-RS overhead by half, the network entity 105 may configure a P value of 16. If the same pattern is used for both polarizations, the network entity 105 may indicate eight bits out of sixteen bits in a bit map to indicate the resources configured for CSI-RS transmission 430. The antenna array 405 may include four sub-groups of size four each, a sub-group 420-a, a sub-group 420-b, a sub-group 420-c, and a sub-group 420-d. The network entity 105 may configure four RBs 425 for CSI-RS transmission, an RB 425-a, an RB 425-b, an RB 425-c, and an RB 425-d.

The network entity 105 may transmit a control signal indicating the P and Q values to a UE 115. The UE 115 may receive the P and Q values and may use a rule to determine the low-density pattern corresponding to the specific {P,Q} pair. In some cases, the network entity 105 may use the same rule to ensure the network entity 105 and the UE 115 use the same low-density pattern for CSI-RS transmission and for CSI-RS reception, respectively.

The UE 115 and the network entity 105 may use a base transmit location rule if P/2>N1 (e.g., if the quantity of antenna ports 415 to select for an RB 425 is greater than the quantity of antenna ports 415 in a sub-group). For a first sub-group 420-a, the rule may configure each antenna port 415 of the first sub-group 420-a to transmit CSI-RS. For the rest of the N2−1 sub-groups, in accordance with the base transmit location rule, if (P/2−N1)≤N2−1, the rule may configure one antenna port 415 per sub-group. The antenna port 415 per sub-group may be a, where 0≤α≤N1−1. For example, the antenna port 415 with index 1 may be configured to transmit CSI-RS in the second sub-group 420-b, the third sub-group 420-c, and the fourth sub-group 420-d. In accordance with the base transmit location rule, if (P/2−N1)>N2, the rule may configure the one antenna port 415 per sub-group, α, and one or more additional antenna ports 415 per sub-group, α+1, to satisfy the quantity of antenna ports configured for CSI-RS transmission, P. For example, the antenna port 415 with index 2 may be configured to transmit CSI-RS in the second sub-group 420-b, resulting in P=8 antenna ports configured for CSI-RS transmission 430 for the first RB 425-a. The remaining 8 antenna ports may refrain from CSI-RS transmission 440 for the first RB 425-a.

The UE 115 and the network entity 105 may use an RB-shifted rule to determine the antenna ports 415 configured for CSI-RS transmission 430 for the other RBs 425. For example, for a next RB 425-b, the positions of antenna ports 415 configured for CSI-RS transmission 430 in the first sub-group 420-a may be shifted by N1. For example, the sub-group configured with each antenna port 415 transmitting CSI-RS may be shifted by N1 to correspond to the second sub-group 420-b. For the other N2−1 sub-groups, the positions of antenna ports 415 configured for CSI-RS transmission 430 may be shifted by N1+1 (e.g., to shift to a different antenna port index). As such, based on α and α+1, the antenna port 415 with index 2 may be configured to transmit CSI-RS in the third sub-group 420-c, the fourth sub-group 420-d, and the first sub-group 420-a (e.g., wrapping around from the fourth sub-group 420-d for the first RB 425-a), and the antenna port 415 with index 3 may be configured to transmit CSI-RS in the third sub-group 420-c, resulting in P=8 antenna ports configured for CSI-RS transmission 430 for the second RB 425-b. Using such a rule for the RB 425-c and the RB 425-d, the UE 115 and the network entity 105 may determine the antenna ports configured for CSI-RS transmission 430 and the antenna ports configured to refrain from CSI-RS transmission 440. Based on such rules, the devices may determine the low-density pattern for CSI-RS transmission based on the Q value, the P value, the N1 value, the N2 value, or some combination thereof, which may be indicated via control signaling. Additionally, or alternatively, the UE 115 and the network entity 105 may store a lookup table to map from any combination of the Q, P, N1, and N2 values to the low-density pattern.

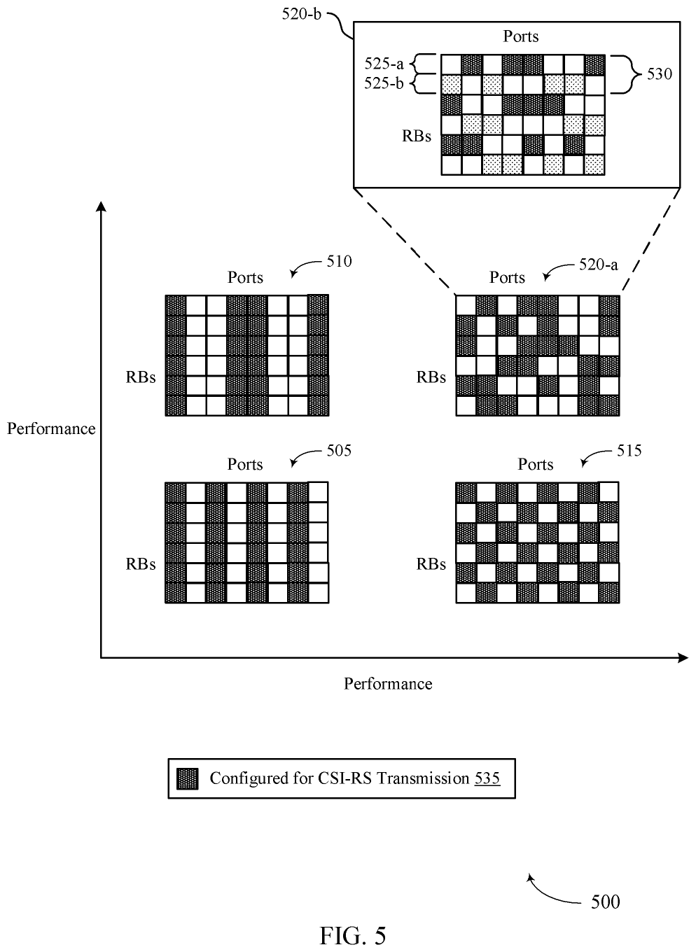

FIG. 5 illustrates an example of low-density patterns 500 that support reference signal pattern association for channel estimation in accordance with one or more aspects of the present disclosure. The low-density patterns 500 may be implemented by aspects of the wireless communications system 100, the network architecture 200, the wireless communications system 300, or any combination thereof. For example, a network entity 105 may select a low-density pattern from the set of low-density patterns 500 for CSI-RS transmission, and a UE 115 may be configured with the selected low-density pattern. The network entity 105 and the UE 115 may be examples of a corresponding network entity 105 and UE 115 as described herein with reference to FIGS. 1 through 4.

Different low-density patterns 500 may correspond to different performance levels and different complexities. In some examples, the low-density patterns 500 may perform at different levels (e.g., a relatively high-performance level, a relatively low-performance level) depending on the configuration of the pattern (e.g., the specific type of low-density pattern). FIG. 5 illustrates the low-density patterns 500 using arrays of blocks with columns representing multiple antenna ports and rows representing multiple RBs. For example, the low-density patterns 500 may correspond to a quantity of antenna ports (e.g., nTx), where a first column represents a first antenna port with an index of 0, a second column represents a second antenna port with an index of 1, a third column represents a third antenna port with an index of 2, up to the total quantity of antenna ports. Additionally, the low-density patterns 500 may correspond to a quantity of frequency resources (e.g., RBs) spanning a frequency range, where a first row represents a first frequency resource (e.g., a first RB), a second row represents a second frequency resource (e.g., a second RB), up to the total quantity of RBs for the frequency range.

A low-density pattern 505 may be an example of a uniform and RB-common low-density pattern. The low-density pattern 505 may be uniform based on the resources configured for CSI-RS transmission 535 being evenly spaced according to a pattern (e.g., even antenna ports configured for CSI-RS transmission 535, odd antenna ports configured to refrain from CSI-RS transmission). For example, the low-density pattern 505 may indicate the first antenna port with an index of 0, the third antenna port with an index of 2, the fifth antenna port with an index of 4, and the seventh antenna port with an index of 6 out of the total set of antenna ports to be configured for CSI-RS transmission 535. Additionally, the low-density pattern 505 may be RB-common, such that each antenna port may be configured to operate the same across the set of RBs (e.g., either transmitting or refraining from transmitting CSI-RSs for each RB). The low-density pattern 505 may support relatively low complexity and latency for configuration based on the uniform and RB-common nature of the low-density pattern 505 (e.g., the low-density pattern 505 may be configured using a relatively small quantity of bits).

A low-density pattern 510 may be an example of a non-uniform and RB-common low-density pattern. The low-density pattern 510 may be non-uniform based on the pattern having inconsistent spacing between resources configured for CSI-RS transmission 535. For example, the low-density pattern 510 may indicate that the antenna ports with indexes of 0, 3, 4, and 7 are configured for CSI-RS transmission 535. Similar to the low-density pattern 505, the low-density pattern 510 may be RB-common, such that each antenna port may be configured to operate the same across the set of RBs (e.g., either transmitting or refraining from transmitting CSI-RSs for each RB). The low-density pattern 510 may support relatively higher performance (e.g., improved channel estimation) than the low-density pattern 505 based on the non-uniformity of the low-density pattern 510.

A low-density pattern 515 may be an example of a uniform and RB-specific low-density pattern. The low-density pattern 515 may be uniform based on the resources configured for CSI-RS transmission 535 being evenly spaced according to a pattern. For example, the antenna ports with even indices may be configured for CSI-RS transmission 535 via RBs with even indices, and the antenna ports with odd indices may be configured for CSI-RS transmission 535 via RBs with odd indices. Additionally, the low-density pattern 515 may be RB-specific, such that an antenna port may be configured to operate differently for different RBs (e.g., a first antenna port may transmit CSI-RS via even RBs but not via odd RBs). The low-density pattern 515 may support relatively higher performance than the low-density pattern 505 based on the RB-specificity of the low-density pattern 515.

A low-density pattern 520-a may be an example of a non-uniform and RB-specific low-density pattern. In some examples, the pattern 520-a may be defined as a randomized pattern where there is no pattern between the antenna ports and the RBs used for CSI-RS transmissions. In some cases, to generate the pattern 520-a, a device may randomly or pseudo-randomly select a quantity of antenna ports (e.g., L antenna ports) out of a total set of antenna ports for each RB. Such a random selection process may result in different antenna ports transmitting CSI-RSs via different quantities of RBs. For example, the pattern 520-a may include different antenna ports configured with different frequency domain densities. As illustrated, the first antenna port may be configured to transmit CSI-RSs via three RBs, while the sixth antenna port may be configured to transmit CSI-RSs via one RB. In some examples, a device may use a random non-uniform and RB-specific low-density pattern to train a neural network for channel estimation. The low-density pattern 520-a may support relatively higher performance than the low-density pattern 510 based on the RB-specificity of the low-density pattern 520-a, and the low-density pattern 520-a may support relatively higher performance than the low-density pattern 515 based on the non-uniformity of the low-density pattern 520-a.

A pattern 520-b may be another example of a non-uniform and RB-specific low-density pattern. In some examples, the pattern 520-b may be defined as a structured-random pattern (e.g., a specific pattern, a specialized pattern) for the CSI-RS transmissions. The pattern 520-b may include the same frequency domain density for each antenna port (e.g., a frequency domain density for each port equal to 0.5). For example, each antenna port may be configured to transmit CSI-RSs via the same quantity of RBs (e.g., three). The pattern 520-b may be defined as a randomized pattern because there is no pattern between the antenna ports and RBs used for transmissions. In some examples, sets of RBs may be grouped together. For example, a first RB 525-a with an index of 0 and a second RB 525-b with an index of 1 may be grouped together to form group 530. In some cases, to structure the random pattern, the low-density pattern 520-b may include the multiple antenna ports that may be configured for the CSI-RS transmission 535 once per group 530. In some cases, to generate the pattern 520-b, a device may randomly or pseudo-randomly select a quantity of antenna ports (e.g., L antenna ports) out of a total set of antenna ports for a first RB 525-a of a group 530. To ensure a consistent frequency domain density, rather than use a random process to select the antenna ports for the second RB 525-b of the group 530, the device may select, for the second RB 525-b, the other antenna ports not selected for the first RB 525-a. In some examples, a network entity 105 may use a structured-random non-uniform and RB-specific low-density pattern for CSI-RS transmissions.

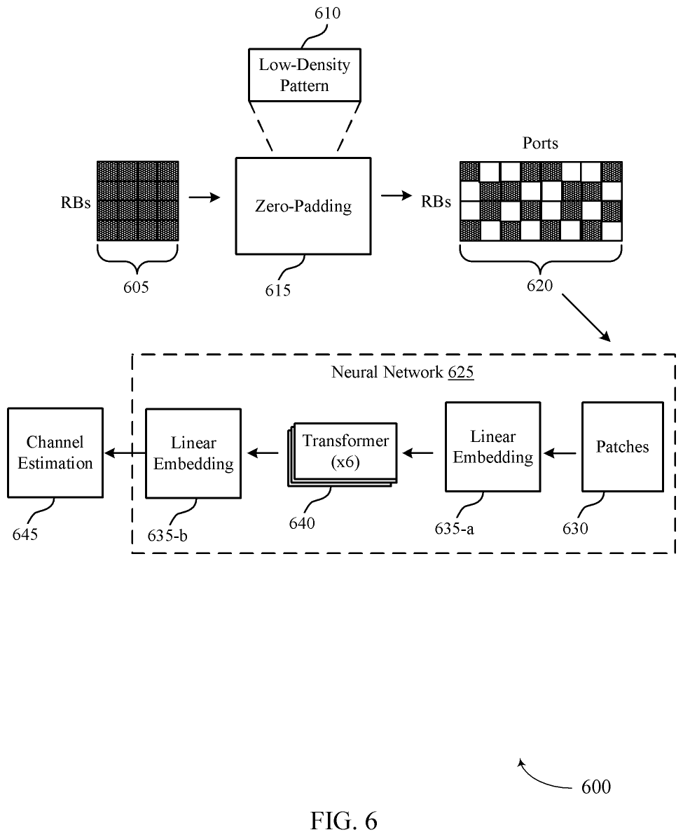

FIG. 6 illustrates an example of a channel estimation procedure 600 that supports reference signal pattern association for channel estimation in accordance with one or more aspects of the present disclosure. The wireless communications system 100, the network architecture 200, the wireless communications system 300, or a combination thereof may implement the channel estimation procedure 600. For example, a UE 115 may use the channel estimation procedure 600 to process CSI-RSs 605 received according to a low-density pattern 610. The UE 115, or another training device or entity, may train one or more neural networks 625 to support the channel estimation procedure 600. The UE 115 may use a neural network 625 to determine full channel measurements (e.g., channel measurements corresponding to each antenna port and each RB in a frequency range) from a reduced set of CSI-RSs 605 (e.g., transmitted according to a low-density pattern 610).

A device, such as a UE 115 or another training device or entity, may train the neural network 625 (e.g., an artificial neural network, a machine learning model, an artificial intelligence (AI) system) to handle CSI-RSs 605 received according to low-density patterns 610. In some examples, the UE 115 and a network entity 105 may jointly design a two-sided model for channel estimation. For example, the network entity 105 may determine a non-orthogonal cover code for multiplexing CSI-RSs 605 and the UE 115 may determine a neural network 625 for channel estimation using machine learning techniques. In some other examples, the UE 115 may design a single-sided model for channel estimation. For example, the UE 115 may train a neural network 625 for channel estimation using machine learning techniques independent of the network entity 105.

In some examples, the device (e.g., a UE 115, a component of the UE 115, another training device) may train a generalized neural network for CSI-RS processing. The generalized neural network may be trained to handle processing of CSI-RSs transmitted using any low-density pattern 610 selected by a network entity 105. The UE 115 may use the generalized neural network to adapt to different low-density patterns 610. For example, a network entity 105 transmitting CSI-RSs 605 according to a low-density pattern 610 may use multiple different low-density patterns 610. In some cases, the network entity 105 may use a randomized low-density pattern. To conserve processing resources and memory resources associated with training neural networks 625, the UE 115 may train the generalized neural network to support any low-density pattern configured by the network entity 105. The device (e.g., the UE 115 or another training device) may use a set of training patterns to train the generalized neural network. For example, the UE 115 may select one or more low-density patterns for training independent of the network entity 105. Once the UE 115 trains the generalized neural network, the UE 115 may deploy the generalized neural network for channel estimation. The UE 115 may use the generalized neural network to process CSI-RSs transmitted according to any low-density pattern selected by the network entity 105.

However, different low-density patterns used for training may result in different channel estimation performances for the resulting generalized neural networks. Additionally, or alternatively, different low-density patterns used for CSI-RS transmission by a network entity 105 may result in different channel estimation performances for the trained generalized neural network. In some cases, the UE 115 may use random antenna port-RB patterns (e.g., with different frequency densities for different antenna ports) for training the generalized neural network. For example, the UE 115 may randomly or pseudo-randomly select L antenna ports from the total set of antenna ports for each RB, and the UE 115 may select different combinations of antenna ports for different RBs. In contrast, the network entity 105 may use structured-random antenna port-RB patterns (e.g., with the same frequency density for each antenna port) for the CSI-RS 605 transmissions (e.g., for the low-density patterns 610 selected by the network entity 105). In some examples, such a configuration may improve performance of processing low-density patterns 610 of CSI-RSs 605.

Alternatively, the UE 115 may train the generalized neural network using structured-random antenna port-RB patterns or any other types of patterns, and the network entity 105 may transmit CSI-RSs according to random antenna port-RB patterns or any other types of patterns.

In some other examples, the device may train one or more neural networks 625 specific to one or more low-density patterns 610. For example, a UE 115 may be configured with one or more low-density pattern options for CSI-RS reception at the UE 115. In some cases, the UE 115, or another training device, may train a neural network 625 to handle processing of CSI-RSs 605 transmitted using the one or more low-density patterns 610. In some other cases, the UE 115, or another training device, may train multiple neural networks 625, and each neural network 625 may be trained to handle processing CSI-RSs 605 transmitted using a specific low-density pattern 610 from the one or more low-density pattern options. A network entity 105 transmitting CSI-RSs 605 may select a low-density pattern 610 from the one or more low-density pattern options and may indicate the selected low-density pattern 610 to the UE 115. The UE 115 may determine which neural network 625 to use for CSI-RS processing based on the indicated low-density pattern 610 (e.g., the neural network 625 trained using the low-density pattern 610).

Training the neural network 625 using a low-density pattern 610 may involve processing a full set of CSI-RSs (e.g., where each antenna port of a total set of antenna ports transmits a CSI-RS via each RB of a set of RBs across a frequency range) to determine channel estimation based on the full set of CSI-RSs. The training device may use the low-density pattern 610 to select a subset of CSI-RSs from the full set of CSI-RSs and may input the subset of CSI-RSs into the neural network 625. The training device may obtain an output from the neural network 625 indicating a channel estimation based on the subset of CSI-RSs. The training device may compare the channel estimation output by the neural network 625 based on the subset of CSI-RSs with the channel estimation determined based on the full set of CSI-RSs. The training device may provide feedback to the neural network 625 based on the comparison. For example, the training device may adjust weight values, nodes, or other aspects of the neural network 625 based on differences between the channel estimations, such that the output of the neural network 625 may more accurately predict the channel estimation based on the full set of CSI-RSs. In some examples, the training device may perform such training processes for multiple received CSI-RSs, multiple low-density patterns 610, or both. Additionally, or alternatively, the training device may be provided CSI-RS measurements, the low-density patterns 610 for training, or both by another device (e.g., a UE 115). In some cases, the training device may periodically or aperiodically refine (e.g., further train) the neural network 625 (e.g., post-deployment).

The UE 115 may use the deployed, trained neural network 625 to handle channel estimation based on a subset of CSI-RSs 605. For example, the UE 115 may receive a set of CSI-RSs from a network entity 105. The UE 115 may perform zero-padding 615 according to a low-density pattern 610 (e.g., a low-density pattern 610 configured by the network entity 105) to resize the array of CSI-RSs 605, y. For example, the zero-padding 615 may use the low-density pattern 610 to map the received CSI-RSs 605 to the antenna ports and RBs over which the CSI-RSs were transmitted. In some examples, the zero-padding 615 may receive an array of CSI-RSs of size N_RB×L (or N_RB×L×2 for both polarizations) and may expand the array to size N_RB×Nₜ (or N_RB×Nₜ×2 for both polarizations), where L is the quantity of antenna ports selected per RB for transmitting CSI-RS and Nₜ is the total quantity of antenna ports at the network entity 105. The UE 115 may use the resulting array 620, yₚ, of CSI-RSs (e.g., one or more measurements of the received CSI-RSs) as input to the trained neural network 625.

In some examples, the neural network 625 may be based on a transformer design for performing channel estimation. The neural network 625 may turn the input array 620, yₚ, into patches 630 corresponding to the different RBs. For example, the neural network 625 may determine N_RB patches 630 of size 1×2Nₜ. The neural network 625 may send the patches 630 to a first linear embedding layer 635-a to change the dimensions of the patches 630 to support input into a model (e.g., into the transformer 640). For example, the first linear embedding layer 635-a may change the dimensions of the patches to N_RB×d_{model}, and d_{model} may be the dimension supported by the transformer 640. The neural network 625 may add a positional encoding to the output of the first linear embedding layer 635-a and may send the resulting data to the transformer 640 (e.g., a set of six layers of transformers). The neural network 625 may send the output of the transformer 640 to a second linear embedding layer 635-b to change the dimensions of the output of the transformer 640 to 2×Nₜ (e.g., for the two polarizations) corresponding to the channel estimation 645, ĥ, of the channel across the total set of antenna ports, Nₜ. Accordingly, the UE 115 may receive the subset of CSI-RSs 605 from a subset of antenna ports and may determine a channel estimation 645 across the total set of antenna ports using the neural network 625 and the configured low-density pattern 610.

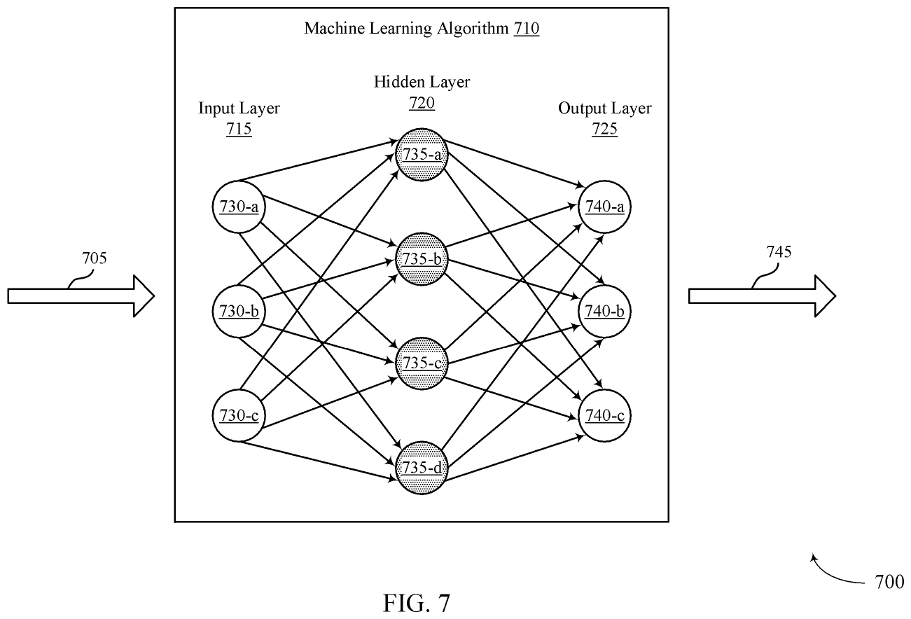

FIG. 7 illustrates an example of a machine learning process 700 that supports reference signal pattern association for channel estimation in accordance with one or more aspects of the present disclosure. The machine learning process 700 may be implemented at a UE 115 or another device supporting machine learning as described with reference to FIGS. 1 through 6. The machine learning process 700 may support training a neural network for channel estimation using one or more low-density patterns of CSI-RSs.

The machine learning process 700 may include a machine learning algorithm 710. As illustrated, the machine learning algorithm 710 may be an example of a neural network (e.g., an artificial neural network), such as an FF or DFF neural network, an RNN, an LSTM neural network, or any other type of neural network. However, any other machine learning algorithms may be supported. For example, the machine learning algorithm 710 may implement a nearest neighbor algorithm, a linear regression algorithm, a Naïve Bayes algorithm, a random forest algorithm, or any other machine learning algorithm. Furthermore, the machine learning process 700 may involve supervised learning, unsupervised learning, semi-supervised learning, reinforcement learning, or any combination thereof.

The machine learning algorithm 710 may include an input layer 715, one or more hidden layers 720, and an output layer 725. In a fully connected neural network with one hidden layer 720, each hidden layer node 735 may receive a value from each input layer node 730 as input, where each input may be weighted. These neural network weights may be based on a cost function that is revised during training of the machine learning algorithm 710. Similarly, each output layer node 740 may receive a value from each hidden layer node 735 as input, where the inputs are weighted. If post-deployment training (e.g., online training) is supported, memory may be allocated to store errors or gradients for reverse matrix multiplication. These errors or gradients may support updating the machine learning algorithm 710 based on output feedback. Training the machine learning algorithm 710 may support computation of the weights (e.g., connecting the input layer nodes 730 to the hidden layer nodes 735 and the hidden layer nodes 735 to the output layer nodes 740) to map an input pattern to a desired output outcome. This training may result in a device-specific machine learning algorithm 710 based on the historic application data and data transfer for a specific network entity 105 or UE 115.

In some examples, input values 705 may be sent to the machine learning algorithm 710 for processing. In some examples, preprocessing may be performed according to a sequence of operations on the input values 705 such that the input values 705 may be in a format that is compatible with the machine learning algorithm 710. In some examples, the pre-processing may involve zero-padding a received set of CSI-RSs according to a low-density pattern, as described herein with reference to FIG. 6. The input values 705 may be converted into a set of k input layer nodes 730 at the input layer 715. In some cases, different measurements may be input at different input layer nodes 730 of the input layer 715. Some input layer nodes 730 may be assigned default values (e.g., values of 0) if the quantity of input layer nodes 730 exceeds the quantity of inputs corresponding to the input values 705. As illustrated, the input layer 715 may include three input layer nodes 730-a, 730-b, and 730-c. However, it is to be understood that the input layer 715 may include any quantity of input layer nodes 730 (e.g., 20 input nodes).

The machine learning algorithm 710 may convert the input layer 715 to a hidden layer 720 based on a quantity of input-to-hidden weights between the k input layer nodes 730 and the n hidden layer nodes 735. The machine learning algorithm 710 may include any quantity of hidden layers 720 as intermediate steps between the input layer 715 and the output layer 725. Additionally, each hidden layer 720 may include any quantity of nodes. For example, as illustrated, the hidden layer 720 may include four hidden layer nodes 735-a, 735-b, 735-c, and 735-d. However, it is to be understood that the hidden layer 720 may include any quantity of hidden layer nodes 735 (e.g., 10 input nodes). In a fully connected neural network, each node in a layer may be based on each node in the previous layer. For example, the value of hidden layer node 735-a may be based on the values of input layer nodes 730-a, 730-b, and 730-c (e.g., with different weights applied to each node value).

The machine learning algorithm 710 may determine values for the output layer nodes 740 of the output layer 725 following one or more hidden layers 720. For example, the machine learning algorithm 710 may convert the hidden layer 720 to the output layer 725 based on a quantity of hidden-to-output weights between the n hidden layer nodes 735 and the m output layer nodes 740. In some cases, n=m. Each output layer node 740 may correspond to a different output value 745 of the machine learning algorithm 710. As illustrated, the machine learning algorithm 710 may include three output layer nodes 740-a, 740-b, and 740-c, supporting three different threshold values. However, it is to be understood that the output layer 725 may include any quantity of output layer nodes 740. In some examples, post-processing may be performed on the output values 745 according to a sequence of operations such that the output values 745 may be in a format that is compatible with reporting the output values 745.

The machine learning algorithm 710 may support neural network training for channel estimation. For example, a device (e.g., a UE 115 or other training device) may train a generalized neural network, a specific neural network, or both using the machine learning process 700. As such, the input values 705 may correspond to CSI measurements associated with CSI-RSs received by the UE 115 according to a low-density pattern for a channel, and the output values 745 may correspond to channel estimation parameters for the full channel (e.g., extrapolated from the subset of CSI-RSs corresponding to the low-density pattern).

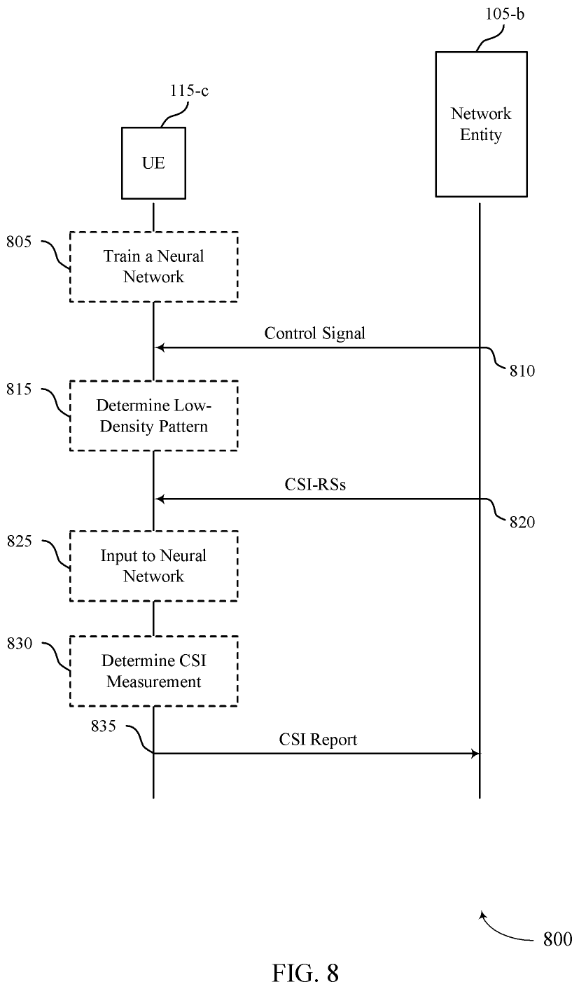

FIG. 8 illustrates an example of a process flow 800 that supports reference signal pattern association for channel estimation in accordance with one or more aspects of the present disclosure. In some examples, the process flow 800 may be implemented by aspects of the wireless communications system 100, the network architecture 200, the wireless communications system 300, or any combination thereof. For example, the process flow 800 may include a network entity 105-b and a UE 115-c, which may be examples of a network entity 105 and a UE 115 as described with reference to FIGS. 1 through 7. In the following description of the process flow 800, the operations between the network entity 105-b and the UE 115-c may be performed in different orders or at different times. Some operations may also be left out of the process flow 800, or other operations may be added. Although the network entity 105-b and the UE 115-c are shown performing the operations of the process flow 800, some aspects of some operations may be performed by one or more other devices.

At 805, the UE 115-c (or another device or component) may train a neural network based on a low-density pattern for CSI-RSs. In some cases, the neural network may be an artificial neural network or some other machine learning model or AI system. In some cases, a device (e.g., the UE 115-c or another device) may train a generalized artificial neural network. The device may obtain a set of multiple CSI-RSs for a set of multiple antenna ports and a set of multiple RBs. For example, the UE 115-c may receive a CSI-RS from each antenna port of the set of multiple antenna ports via each RB of the set of multiple RBs. The device may determine a low-density pattern for an artificial neural network training procedure. For example, the device may randomly or pseudo-randomly select, or may be configured with, the low-density pattern for training. The device may train the generalized artificial neural network based on a subset of the obtained set of multiple CSI-RSs in accordance with the determined low-density pattern. For example, the low-density pattern may indicate a subset of the set of multiple CSI-RSs for one or more RBs of the set of multiple RBs to use for the training. In some examples, the device may use multiple random low-density patterns to train the generalized artificial neural network. The device may output the trained generalized artificial neural network, for example, for use by the UE 115-c for channel estimation.

In some other cases, the device (e.g., the UE 115-c or another device) may train one or more specific artificial neural networks. For example, a specific artificial neural network may be trained using one or more specific low-density patterns, such that the neural network may perform channel estimation using CSI-RSs received using the one or more specific patterns. The UE 115-c may be configured (e.g., pre-configured, configured by the network entity 105-b) with a set of multiple low-density patterns. The UE 115-c may train one or more artificial neural networks specific to the set of multiple low-density patterns (e.g., a different neural network for each configured low-density pattern or a neural network for the set of multiple configured low-density patterns).

The device may obtain a set of multiple CSI-RSs for a set of multiple antenna ports and a set of multiple RBs. For example, the UE 115-c may receive a CSI-RS from each antenna port of the set of multiple antenna ports via each RB of the set of multiple RBs. The device may train an artificial neural network specific to one or more low-density patterns configured at the device (e.g., provided to the device, stored at the device) based on a subset of the obtained set of multiple CSI-RSs in accordance with the one or more low-density patterns. The device may output the trained artificial neural network, for example, for use by the UE 115-c for channel estimation for the specific one or more low-density patterns. In some cases, the device may output the trained artificial neural network with an indication that the neural network is specific to the one or more low-density patterns. If the UE 115-c is configured with a low-density pattern (e.g., by the network entity 105-b), the UE 115-c may select a specific neural network to use based on the configured low-density pattern (e.g., the neural network trained using the configured low-density pattern).

At 810, the network entity 105-b may output (e.g., transmit) a control signal to the UE 115-c. In some examples, the control signal may configure the low-density pattern for CSI-RS reception at the UE 115-c for a set of multiple antenna ports at the network entity 105-b. The low-density pattern may indicate a subset of the set of multiple antenna ports for the CSI-RS reception at the UE 115-c via one or more RBs. In some cases, the control signal may indicate a mapping from the subset of the set of antenna ports to the set of antenna ports used for the one or more RBs. In some cases, the mapping may be specific to an RB, an RB group, or is common to a set of RBs in a frequency band that corresponds to the CSI-RS reception. In some examples, the control signal may include a bit map to indicate the low-density pattern for the CSI-RS reception. In some cases, the control signal may include assistance information for an antenna configuration with the set of antenna ports, a channel type, environmental information, transmission correlation information, or a combination thereof. In some examples, the control signal may include a bit map, quantities of antenna ports, or an index of the low-density pattern to use for the UE 115-b.

At 815, the UE 115-c may determine the low-density pattern from the control signal. In some examples, the mapping from the control signal may be used to indicate an association between the one or more antenna ports and RBs. For example, some associations, such as an antenna port muting pattern, an RB muting pattern, a cover code association, or some combination thereof, may be used to determine the low-density pattern. In some cases, the low-density pattern may indicate the subset of the set of antenna ports for the CSI-RS reception via one or more RBs. In some examples, the low-density pattern may be based on quantities of antenna ports, a rule, a lookup table, or a combination thereof.

At 820, the network entity 105-b may transmit the CSI-RSs to the UE 115-c. In some examples, the CSI-RSs may be transmitted based on the low-density pattern indicated by the control signal. In some cases, the network entity 105-b may use a structured-random low-density pattern for the CSI-RS transmission.

At 825, the UE 115-c may input the CSI-RSs to the neural network. In some examples, the CSI-RSs may be zero-padded based on the low-density pattern. The neural network may input the zero-padded CSI-RSs into the neural network to determine a CSI measurement.

At 830, the UE 115-c may determine the CSI measurement based on the neural network and receiving the set of CSI-RSs based on the low-density pattern. In some cases, the CSI measurement may be included in the CSI report. For example, the UE 115-c may generate a CSI report including one or more CSI measurements, one or more channel estimation parameters, or a combination thereof. At 835, the UE 115-c may transmit the CSI report to the network entity 105-b.

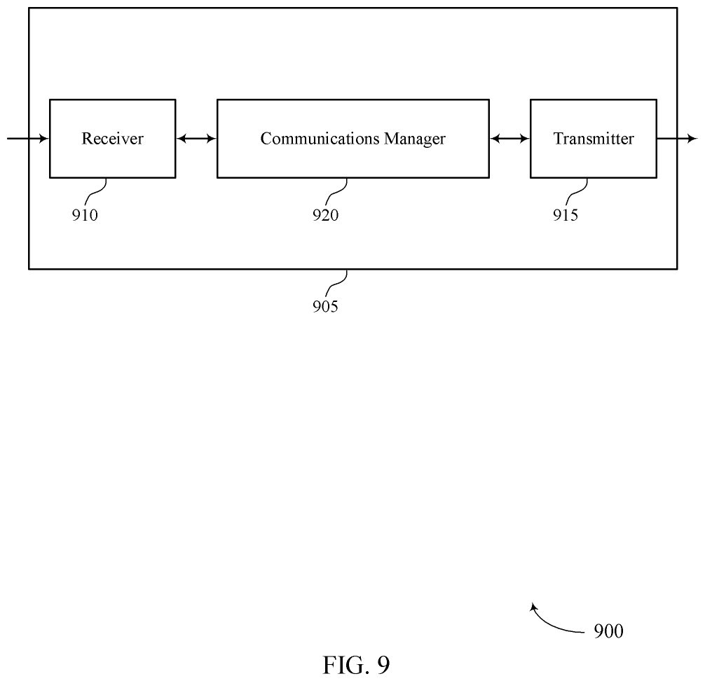

FIG. 9 shows a block diagram 900 of a device 905 that supports reference signal pattern association for channel estimation in accordance with one or more aspects of the present disclosure. The device 905 may be an example of aspects of a UE 115 or a neural network training device as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to reference signal pattern association for channel estimation). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to reference signal pattern association for channel estimation). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations thereof or various components thereof may be examples of means for performing various aspects of reference signal pattern association for channel estimation as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications at a device (e.g., a UE) in accordance with examples as disclosed herein. For example, the communications manager 920 may be configured as or otherwise support a means for receiving, from a network entity, a control signal configuring a low-density pattern for CSI-RS reception for a set of multiple antenna ports, where the low-density pattern indicates a subset of the set of multiple antenna ports for the CSI-RS reception via one or more RBs. The communications manager 920 may be configured as or otherwise support a means for receiving, from the network entity, a set of multiple CSI-RSs in accordance with the low-density pattern. The communications manager 920 may be configured as or otherwise support a means for transmitting, to the network entity, a CSI report based on the set of multiple CSI-RSs.

Additionally, or alternatively, the communications manager 920 may support wireless communications at a device in accordance with examples as disclosed herein. For example, the communications manager 920 may be configured as or otherwise support a means for obtaining a set of multiple CSI-RSs for a set of multiple antenna ports and a set of multiple RBs. The communications manager 920 may be configured as or otherwise support a means for determining a low-density pattern for an artificial neural network training procedure. The communications manager 920 may be configured as or otherwise support a means for training a generalized artificial neural network based on a subset of the set of multiple CSI-RSs in accordance with the determined low-density pattern, where the determined low-density pattern indicates a subset of the set of multiple antenna ports for one or more RBs of the set of multiple RBs. The communications manager 920 may be configured as or otherwise support a means for outputting the trained generalized artificial neural network.

Additionally, or alternatively, the communications manager 920 may support wireless communications at a device in accordance with examples as disclosed herein. For example, the communications manager 920 may be configured as or otherwise support a means for obtaining a set of multiple CSI-RSs for a set of multiple antenna ports and a set of multiple RBs. The communications manager 920 may be configured as or otherwise support a means for training an artificial neural network specific to one or more low-density patterns configured at the device based on a subset of the set of multiple CSI-RSs in accordance with the one or more low-density patterns, where a low-density pattern of the one or more low-density patterns indicates a subset of the set of multiple antenna ports for one or more RBs of the set of multiple RBs. The communications manager 920 may be configured as or otherwise support a means for outputting the trained artificial neural network.

By including or configuring the communications manager 920 in accordance with examples as described herein, the device 905 (e.g., a processor controlling or otherwise coupled with the receiver 910, the transmitter 915, the communications manager 920, or a combination thereof) may support techniques for reducing processing overhead and power consumption associated with CSI-RS reception and processing. For example, the device 905 may reduce a quantity of CSI-RSs processed at the device 905 according to a low-density pattern. The device 905 may maintain accurate channel estimation for the full channel using the low-density pattern of CSI-RSs, for example, based on training an artificial neural network.

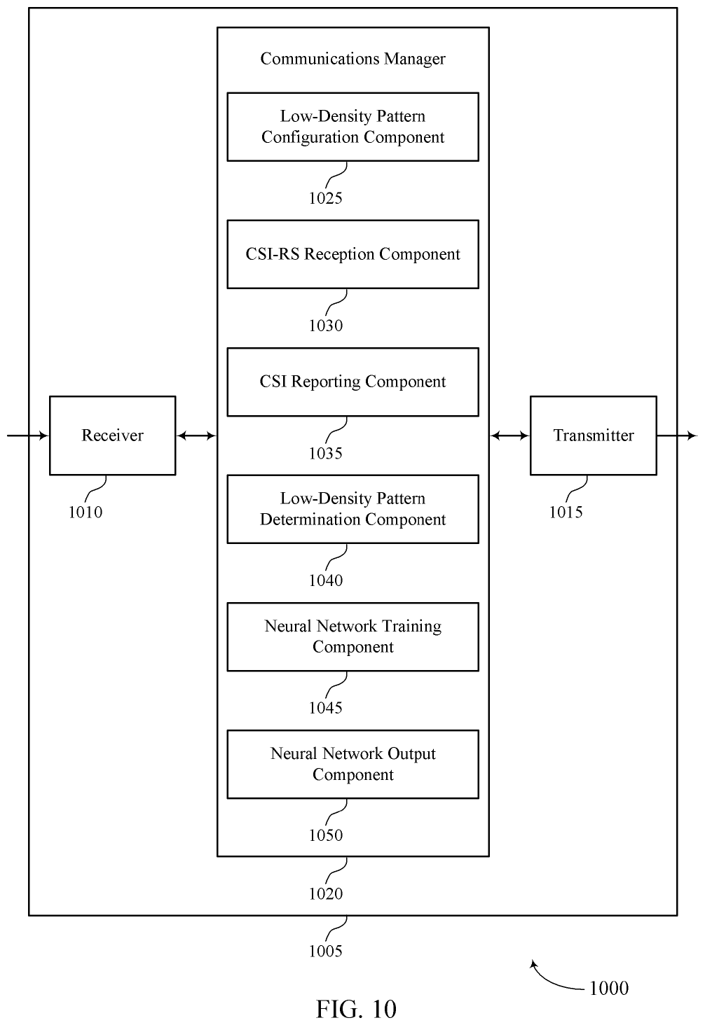

FIG. 10 shows a block diagram 1000 of a device 1005 that supports reference signal pattern association for channel estimation in accordance with one or more aspects of the present disclosure. The device 1005 may be an example of aspects of a device 905, a UE 115, or a neural network training device as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to reference signal pattern association for channel estimation). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to reference signal pattern association for channel estimation). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of reference signal pattern association for channel estimation as described herein. For example, the communications manager 1020 may include a low-density pattern configuration component 1025, a CSI-RS reception component 1030, a CSI reporting component 1035, a low-density pattern determination component 1040, a neural network training component 1045, a neural network output component 1050, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications at a UE in accordance with examples as disclosed herein. The low-density pattern configuration component 1025 may be configured as or otherwise support a means for receiving, from a network entity, a control signal configuring a low-density pattern for CSI-RS reception for a set of multiple antenna ports, where the low-density pattern indicates a subset of the set of multiple antenna ports for the CSI-RS reception via one or more RBs. The CSI-RS reception component 1030 may be configured as or otherwise support a means for receiving, from the network entity, a set of multiple CSI-RSs in accordance with the low-density pattern. The CSI reporting component 1035 may be configured as or otherwise support a means for transmitting, to the network entity, a CSI report based on the set of multiple CSI-RSs.

Additionally, or alternatively, the communications manager 1020 may support wireless communications at a device in accordance with examples as disclosed herein. The CSI-RS reception component 1030 may be configured as or otherwise support a means for obtaining a set of multiple CSI-RSs for a set of multiple antenna ports and a set of multiple RBs. The low-density pattern determination component 1040 may be configured as or otherwise support a means for determining a low-density pattern for an artificial neural network training procedure. The neural network training component 1045 may be configured as or otherwise support a means for training a generalized artificial neural network based on a subset of the set of multiple CSI-RSs in accordance with the determined low-density pattern, where the determined low-density pattern indicates a subset of the set of multiple antenna ports for one or more RBs of the set of multiple RBs. The neural network output component 1050 may be configured as or otherwise support a means for outputting the trained generalized artificial neural network.

Additionally, or alternatively, the communications manager 1020 may support wireless communications at a device in accordance with examples as disclosed herein. The CSI-RS reception component 1030 may be configured as or otherwise support a means for obtaining a set of multiple CSI-RSs for a set of multiple antenna ports and a set of multiple RBs. The neural network training component 1045 may be configured as or otherwise support a means for training an artificial neural network specific to one or more low-density patterns configured at the device based on a subset of the set of multiple CSI-RSs in accordance with the one or more low-density patterns, where a low-density pattern of the one or more low-density patterns indicates a subset of the set of multiple antenna ports for one or more RBs of the set of multiple RBs. The neural network output component 1050 may be configured as or otherwise support a means for outputting the trained artificial neural network.

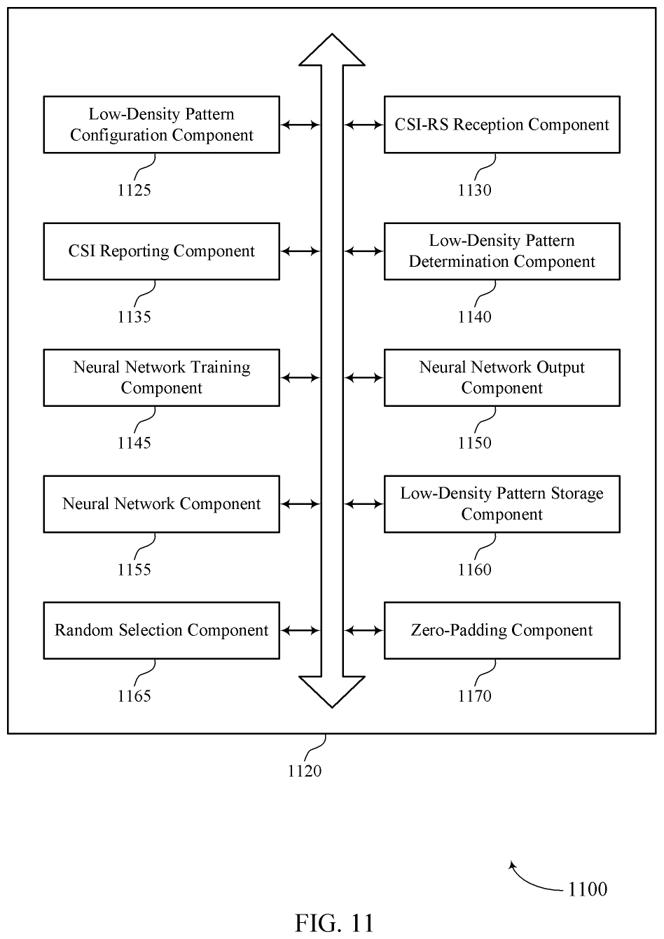

FIG. 11 shows a block diagram 1100 of a communications manager 1120 that supports reference signal pattern association for channel estimation in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of reference signal pattern association for channel estimation as described herein. For example, the communications manager 1120 may include a low-density pattern configuration component 1125, a CSI-RS reception component 1130, a CSI reporting component 1135, a low-density pattern determination component 1140, a neural network training component 1145, a neural network output component 1150, a neural network component 1155, a low-density pattern storage component 1160, a random selection component 1165, a zero-padding component 1170, or any combination thereof. Each of these components may communicate, directly or indirectly, with one another (e.g., via one or more buses).

The communications manager 1120 may support wireless communications at a UE in accordance with examples as disclosed herein. The low-density pattern configuration component 1125 may be configured as or otherwise support a means for receiving, from a network entity, a control signal configuring a low-density pattern for CSI-RS reception for a set of multiple antenna ports, where the low-density pattern indicates a subset of the set of multiple antenna ports for the CSI-RS reception via one or more RBs. The CSI-RS reception component 1130 may be configured as or otherwise support a means for receiving, from the network entity, a set of multiple CSI-RSs in accordance with the low-density pattern. The CSI reporting component 1135 may be configured as or otherwise support a means for transmitting, to the network entity, a CSI report based on the set of multiple CSI-RSs.

In some examples, the low-density pattern configuration component 1125 may be configured as or otherwise support a means for determining the low-density pattern based on the control signal indicating a mapping from the subset of the set of multiple antenna ports to the set of multiple antenna ports for the one or more RBs. In some examples, the mapping is specific to an RB, is specific to an RB group, or is common to a set of multiple RBs in a frequency band corresponding to the CSI-RS reception.

In some examples, the low-density pattern configuration component 1125 may be configured as or otherwise support a means for determining the low-density pattern based on the control signal indicating an RB muting pattern for one or more antenna ports of the set of multiple antenna ports. In some examples, the RB muting pattern is specific to an antenna port of the set of multiple antenna ports, is specific to a group of antenna ports of the set of multiple antenna ports, or is common to the set of multiple antenna ports.

In some examples, the low-density pattern configuration component 1125 may be configured as or otherwise support a means for determining the low-density pattern based on the control signal indicating an antenna port muting pattern for the one or more RBs. In some examples, the antenna port muting pattern is specific to an RB, is specific to an RB group, or is common to a set of multiple RBs in a frequency band corresponding to the CSI-RS reception.

In some examples, the low-density pattern configuration component 1125 may be configured as or otherwise support a means for determining the low-density pattern based on the control signal indicating a cover code that configures a set of multiple antenna port-RB pairs to use for the CSI-RS reception.

In some examples, the neural network component 1155 may be configured as or otherwise support a means for determining a CSI measurement based on an artificial neural network and the set of multiple CSI-RSs received in accordance with the low-density pattern, where the CSI report includes the CSI measurement.

In some examples, the zero-padding component 1170 may be configured as or otherwise support a means for zero-padding the received set of multiple CSI-RSs based on the low-density pattern. In some examples, the neural network component 1155 may be configured as or otherwise support a means for inputting the zero-padded received set of multiple CSI-RSs into the artificial neural network, where the CSI measurement is determined based on an output of the artificial neural network. In some examples, the neural network component 1155 may be configured as or otherwise support a means for training the artificial neural network based on the low-density pattern.

In some examples, the control signal includes a bit map that indicates the low-density pattern for the CSI-RS reception.

In some examples, the control signal indicates a first quantity of the subset of the set of multiple antenna ports and a second quantity of the set of multiple antenna ports, and the low-density pattern configuration component 1125 may be configured as or otherwise support a means for determining the low-density pattern for the CSI-RS reception based on the first quantity, the second quantity, and a rule, a lookup table, or both for mapping from the first quantity and the second quantity to the low-density pattern.

In some examples, the low-density pattern storage component 1160 may be configured as or otherwise support a means for storing a set of multiple low-density patterns, where the control signal includes an index value indicating the low-density pattern from the set of multiple low-density patterns.

In some examples, the control signal further includes assistance information that indicates an antenna configuration corresponding to the set of multiple antenna ports, a channel type, environmental information, transmission correlation information, or a combination thereof. In some examples, the CSI report is further based on the assistance information.

Additionally, or alternatively, the communications manager 1120 may support wireless communications at a device in accordance with examples as disclosed herein. In some examples, the CSI-RS reception component 1130 may be configured as or otherwise support a means for obtaining a set of multiple CSI-RSs for a set of multiple antenna ports and a set of multiple RBs. The low-density pattern determination component 1140 may be configured as or otherwise support a means for determining a low-density pattern for an artificial neural network training procedure. The neural network training component 1145 may be configured as or otherwise support a means for training a generalized artificial neural network based on a subset of the set of multiple CSI-RSs in accordance with the determined low-density pattern, where the determined low-density pattern indicates a subset of the set of multiple antenna ports for one or more RBs of the set of multiple RBs. The neural network output component 1150 may be configured as or otherwise support a means for outputting the trained generalized artificial neural network.

In some examples, the low-density pattern determination component 1140 may be configured as or otherwise support a means for determining one or more additional low-density patterns for the artificial neural network training procedure. In some examples, the neural network training component 1145 may be configured as or otherwise support a means for further training the generalized artificial neural network based on the one or more additional low-density patterns.

In some examples, the random selection component 1165 may be configured as or otherwise support a means for randomly selecting one or more low-density patterns, where the low-density pattern is determined based on the random selection.

In some examples, the determined low-density pattern indicates a random selection of the subset of the set of multiple antenna ports for each RB of the set of multiple RBs. In some other examples, the determined low-density pattern indicates a random selection of the subset of the set of multiple antenna ports for a first set of RBs of the set of multiple RBs, and a selection of the subset of the set of multiple antenna ports for a second set of RBs of the set of multiple RBs is based on the random selection of the subset of the set of multiple antenna ports for the first set of RBs.

Additionally, or alternatively, the communications manager 1120 may support wireless communications at a device in accordance with examples as disclosed herein. In some examples, the CSI-RS reception component 1130 may be configured as or otherwise support a means for obtaining a set of multiple CSI-RSs for a set of multiple antenna ports and a set of multiple RBs. In some examples, the neural network training component 1145 may be configured as or otherwise support a means for training an artificial neural network specific to one or more low-density patterns configured at the device based on a subset of the set of multiple CSI-RSs in accordance with the one or more low-density patterns, where a low-density pattern of the one or more low-density patterns indicates a subset of the set of multiple antenna ports for one or more RBs of the set of multiple RBs. In some examples, the neural network output component 1150 may be configured as or otherwise support a means for outputting the trained artificial neural network.

In some examples, the low-density pattern configuration component 1125 may be configured as or otherwise support a means for obtaining a configuration of the one or more low-density patterns, where the artificial neural network is trained based on the configuration.

In some examples, the low-density pattern storage component 1160 may be configured as or otherwise support a means for storing the one or more low-density patterns at the device, where the artificial neural network is trained based on the stored one or more low-density patterns.

In some examples, the artificial neural network is specific to a low-density pattern, and the neural network training component 1145 may be configured as or otherwise support a means for training one or more additional artificial neural networks specific to one or more additional low-density patterns configured at the device. In some examples, the artificial neural network is specific to a low-density pattern, and the neural network output component 1150 may be configured as or otherwise support a means for outputting the one or more additional trained artificial neural networks.

In some examples, to support outputting the trained artificial neural network, the neural network output component 1150 may be configured as or otherwise support a means for outputting the trained artificial neural network with an indication that the trained artificial neural network is specific to the one or more low-density patterns.

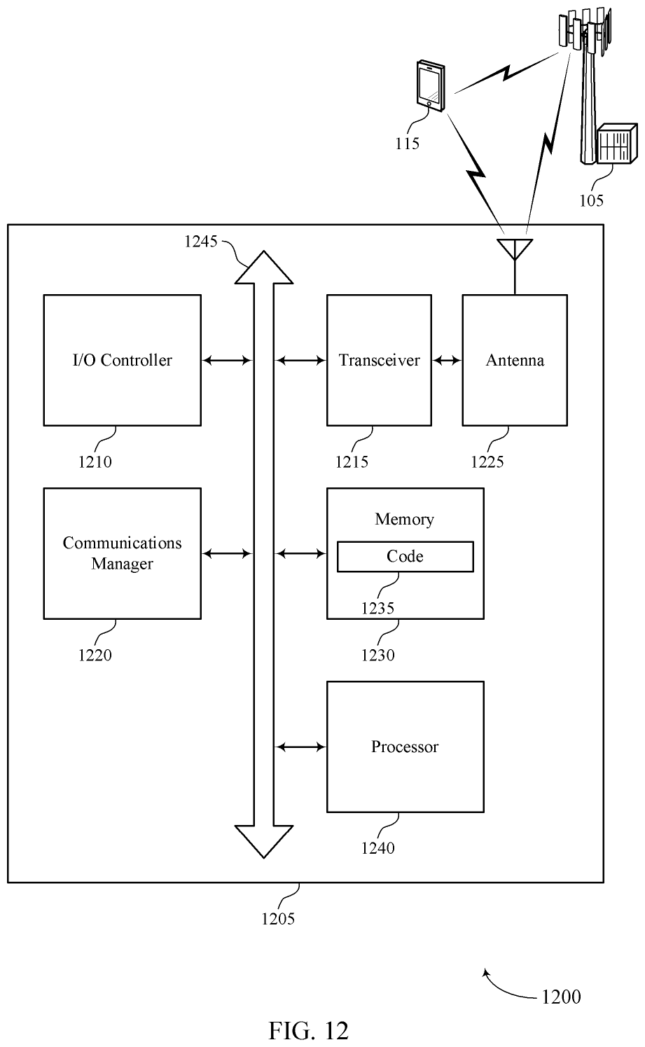

FIG. 12 shows a diagram of a system 1200 including a device 1205 that supports reference signal pattern association for channel estimation in accordance with one or more aspects of the present disclosure. The device 1205 may be an example of or include the components of a device 905, a device 1005, a UE 115, or a neural network training device as described herein. The device 1205 may communicate (e.g., wirelessly) with one or more network entities 105, one or more UEs 115, or any combination thereof. The device 1205 may include components for bi-directional voice and data communications including components for transmitting and receiving communications, such as a communications manager 1220, an input/output (I/O) controller 1210, a transceiver 1215, an antenna 1225, a memory 1230, code 1235, and a processor 1240. These components may be in electronic communication or otherwise coupled (e.g., operatively, communicatively, functionally, electronically, electrically) via one or more buses (e.g., a bus 1245).

The I/O controller 1210 may manage input and output signals for the device 1205. The I/O controller 1210 may also manage peripherals not integrated into the device 1205. In some cases, the I/O controller 1210 may represent a physical connection or port to an external peripheral. In some cases, the I/O controller 1210 may utilize an operating system such as iOS®, ANDROID®, MS-DOS®, MS-WINDOWS®, OS/2®, UNIX®, LINUX®, or another known operating system. Additionally or alternatively, the I/O controller 1210 may represent or interact with a modem, a keyboard, a mouse, a touchscreen, or a similar device. In some cases, the I/O controller 1210 may be implemented as part of a processor, such as the processor 1240. In some cases, a user may interact with the device 1205 via the I/O controller 1210 or via hardware components controlled by the I/O controller 1210.

In some cases, the device 1205 may include a single antenna 1225. However, in some other cases, the device 1205 may have more than one antenna 1225, which may be capable of concurrently transmitting or receiving multiple wireless transmissions. The transceiver 1215 may communicate bi-directionally, via the one or more antennas 1225, wired, or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The memory 1230 may include random access memory (RAM) and read-only memory (ROM). The memory 1230 may store computer-readable, computer-executable code 1235 including instructions that, when executed by the processor 1240, cause the device 1205 to perform various functions described herein. The code 1235 may be stored in a non-transitory computer-readable medium such as system memory or another type of memory. In some cases, the code 1235 may not be directly executable by the processor 1240 but may cause a computer (e.g., when compiled and executed) to perform functions described herein. In some cases, the memory 1230 may contain, among other things, a basic I/O system (BIOS) which may control basic hardware or software operation such as the interaction with peripheral components or devices.

The processor 1240 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1240 may be configured to operate a memory array using a memory controller. In some other cases, a memory controller may be integrated into the processor 1240. The processor 1240 may be configured to execute computer-readable instructions stored in a memory (e.g., the memory 1230) to cause the device 1205 to perform various functions (e.g., functions or tasks supporting reference signal pattern association for channel estimation). For example, the device 1205 or a component of the device 1205 may include a processor 1240 and memory 1230 coupled with or to the processor 1240, the processor 1240 and memory 1230 configured to perform various functions described herein.

The communications manager 1220 may support wireless communications at a UE in accordance with examples as disclosed herein. For example, the communications manager 1220 may be configured as or otherwise support a means for receiving, from a network entity, a control signal configuring a low-density pattern for CSI-RS reception for a set of multiple antenna ports, where the low-density pattern indicates a subset of the set of multiple antenna ports for the CSI-RS reception via one or more RBs. The communications manager 1220 may be configured as or otherwise support a means for receiving, from the network entity, a set of multiple CSI-RSs in accordance with the low-density pattern. The communications manager 1220 may be configured as or otherwise support a means for transmitting, to the network entity, a CSI report based on the set of multiple CSI-RSs.

Additionally, or alternatively, the communications manager 1220 may support wireless communications at a device in accordance with examples as disclosed herein. For example, the communications manager 1220 may be configured as or otherwise support a means for obtaining a set of multiple CSI-RSs for a set of multiple antenna ports and a set of multiple RBs. The communications manager 1220 may be configured as or otherwise support a means for determining a low-density pattern for an artificial neural network training procedure. The communications manager 1220 may be configured as or otherwise support a means for training a generalized artificial neural network based on a subset of the set of multiple CSI-RSs in accordance with the determined low-density pattern, where the determined low-density pattern indicates a subset of the set of multiple antenna ports for one or more resource blocks of the set of multiple RBs. The communications manager 1220 may be configured as or otherwise support a means for outputting the trained generalized artificial neural network.

Additionally, or alternatively, the communications manager 1220 may support wireless communications at a device in accordance with examples as disclosed herein. For example, the communications manager 1220 may be configured as or otherwise support a means for obtaining a set of multiple CSI-RSs for a set of multiple antenna ports and a set of multiple RBs. The communications manager 1220 may be configured as or otherwise support a means for training an artificial neural network specific to one or more low-density patterns configured at the device based on a subset of the set of multiple CSI-RSs in accordance with the one or more low-density patterns, where a low-density pattern of the one or more low-density patterns indicates a subset of the set of multiple antenna ports for one or more RBs of the set of multiple RBs. The communications manager 1220 may be configured as or otherwise support a means for outputting the trained artificial neural network.

By including or configuring the communications manager 1220 in accordance with examples as described herein, the device 1205 may support techniques for reduced processing overhead, reduced power consumption, and reduced channel overhead associated with CSI-RS signaling and processing. For example, the device 1205 may perform channel estimation using a reduced set of CSI-RSs in accordance with a low-density pattern, and the device 1205 may train and use a neural network for reliable channel estimation based on the reduced set of CSI-RSs.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the processor 1240, the memory 1230, the code 1235, or any combination thereof. For example, the code 1235 may include instructions executable by the processor 1240 to cause the device 1205 to perform various aspects of reference signal pattern association for channel estimation as described herein, or the processor 1240 and the memory 1230 may be otherwise configured to perform or support such operations.

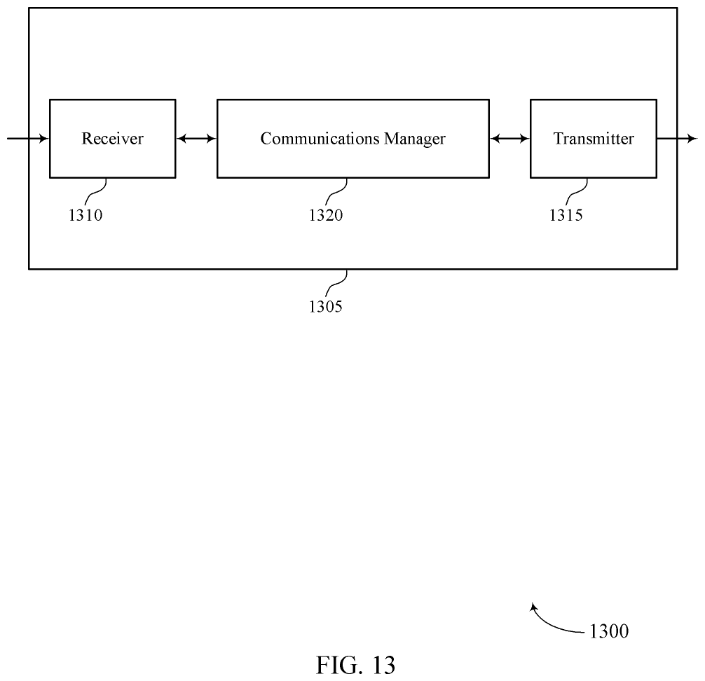

FIG. 13 shows a block diagram 1300 of a device 1305 that supports reference signal pattern association for channel estimation in accordance with one or more aspects of the present disclosure. The device 1305 may be an example of aspects of a network entity 105 as described herein. The device 1305 may include a receiver 1310, a transmitter 1315, and a communications manager 1320. The device 1305 may also include a processor. Each of these components may be in communication with one another (e.g., via one or more buses).

The receiver 1310 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1305. In some examples, the receiver 1310 may support obtaining information by receiving signals via one or more antennas. Additionally, or alternatively, the receiver 1310 may support obtaining information by receiving signals via one or more wired (e.g., electrical, fiber optic) interfaces, wireless interfaces, or any combination thereof.

The transmitter 1315 may provide a means for outputting (e.g., transmitting, providing, conveying, sending) information generated by other components of the device 1305. For example, the transmitter 1315 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1315 may support outputting information by transmitting signals via one or more antennas. Additionally, or alternatively, the transmitter 1315 may support outputting information by transmitting signals via one or more wired (e.g., electrical, fiber optic) interfaces, wireless interfaces, or any combination thereof. In some examples, the transmitter 1315 and the receiver 1310 may be co-located in a transceiver, which may include or be coupled with a modem.

The communications manager 1320, the receiver 1310, the transmitter 1315, or various combinations thereof or various components thereof may be examples of means for performing various aspects of reference signal pattern association for channel estimation as described herein. For example, the communications manager 1320, the receiver 1310, the transmitter 1315, or various combinations or components thereof may support a method for performing one or more of the functions described herein.

In some examples, the communications manager 1320, the receiver 1310, the transmitter 1315, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1320, the receiver 1310, the transmitter 1315, or various combinations or components thereof may be implemented in code (e.g., as communications management software or firmware) executed by a processor. If implemented in code executed by a processor, the functions of the communications manager 1320, the receiver 1310, the transmitter 1315, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1320 may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The communications manager 1320 may support wireless communications at a network entity in accordance with examples as disclosed herein. For example, the communications manager 1320 may be configured as or otherwise support a means for outputting a control signal configuring a low-density pattern for CSI-RS reception at a UE for a set of multiple antenna ports, where the low-density pattern indicates a subset of the set of multiple antenna ports for the CSI-RS reception via one or more RBs. The communications manager 1320 may be configured as or otherwise support a means for outputting a set of multiple CSI-RSs in accordance with the low-density pattern. The communications manager 1320 may be configured as or otherwise support a means for obtaining a CSI report based on the set of multiple CSI-RSs.

By including or configuring the communications manager 1320 in accordance with examples as described herein, the device 1305 (e.g., a processor controlling or otherwise coupled with the receiver 1310, the transmitter 1315, the communications manager 1320, or a combination thereof) may support techniques for reduced power consumption and reduced processing overhead associated with CSI-RS transmission.

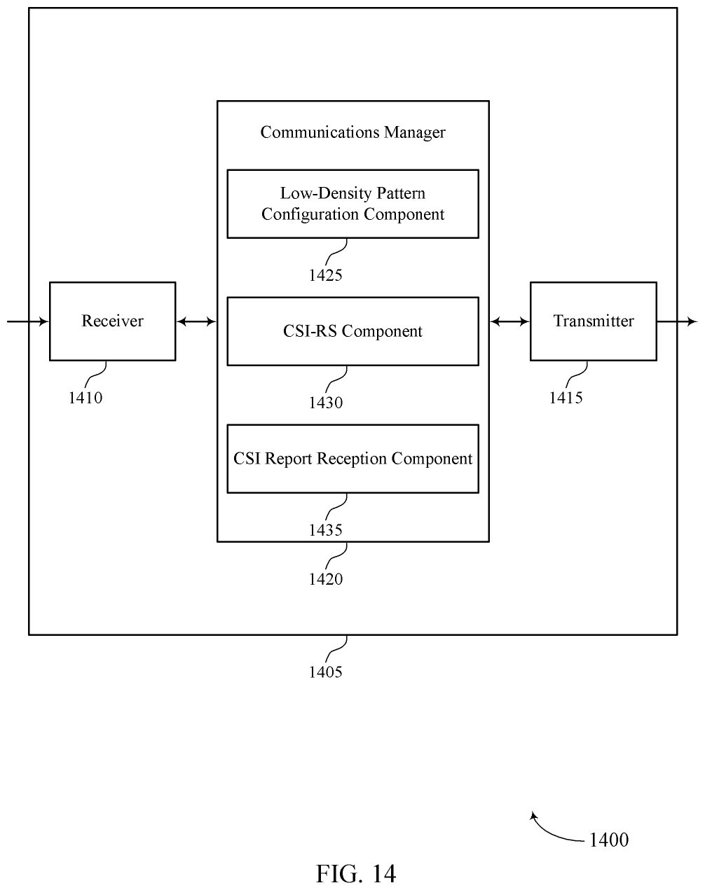

FIG. 14 shows a block diagram 1400 of a device 1405 that supports reference signal pattern association for channel estimation in accordance with one or more aspects of the present disclosure. The device 1405 may be an example of aspects of a device 1305 or a network entity 105 as described herein. The device 1405 may include a receiver 1410, a transmitter 1415, and a communications manager 1420. The device 1405 may also include a processor. Each of these components may be in communication with one another (e.g., via one or more buses).

The receiver 1410 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1405. In some examples, the receiver 1410 may support obtaining information by receiving signals via one or more antennas. Additionally, or alternatively, the receiver 1410 may support obtaining information by receiving signals via one or more wired (e.g., electrical, fiber optic) interfaces, wireless interfaces, or any combination thereof.

The transmitter 1415 may provide a means for outputting (e.g., transmitting, providing, conveying, sending) information generated by other components of the device 1405. For example, the transmitter 1415 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1415 may support outputting information by transmitting signals via one or more antennas. Additionally, or alternatively, the transmitter 1415 may support outputting information by transmitting signals via one or more wired (e.g., electrical, fiber optic) interfaces, wireless interfaces, or any combination thereof. In some examples, the transmitter 1415 and the receiver 1410 may be co-located in a transceiver, which may include or be coupled with a modem.

The device 1405, or various components thereof, may be an example of means for performing various aspects of reference signal pattern association for channel estimation as described herein. For example, the communications manager 1420 may include a low-density pattern configuration component 1425, a CSI-RS component 1430, a CSI report reception component 1435, or any combination thereof. The communications manager 1420 may be an example of aspects of a communications manager 1320 as described herein. In some examples, the communications manager 1420, or various components thereof, may be configured to perform various operations (e.g., receiving, obtaining, monitoring, outputting, transmitting) using or otherwise in cooperation with the receiver 1410, the transmitter 1415, or both. For example, the communications manager 1420 may receive information from the receiver 1410, send information to the transmitter 1415, or be integrated in combination with the receiver 1410, the transmitter 1415, or both to obtain information, output information, or perform various other operations as described herein.

The communications manager 1420 may support wireless communications at a network entity in accordance with examples as disclosed herein. The low-density pattern configuration component 1425 may be configured as or otherwise support a means for outputting a control signal configuring a low-density pattern for CSI-RS reception at a UE for a set of multiple antenna ports, where the low-density pattern indicates a subset of the set of multiple antenna ports for the CSI-RS reception via one or more RBs. The CSI-RS component 1430 may be configured as or otherwise support a means for outputting a set of multiple CSI-RSs in accordance with the low-density pattern. The CSI report reception component 1435 may be configured as or otherwise support a means for obtaining a CSI report based on the set of multiple CSI-RSs.

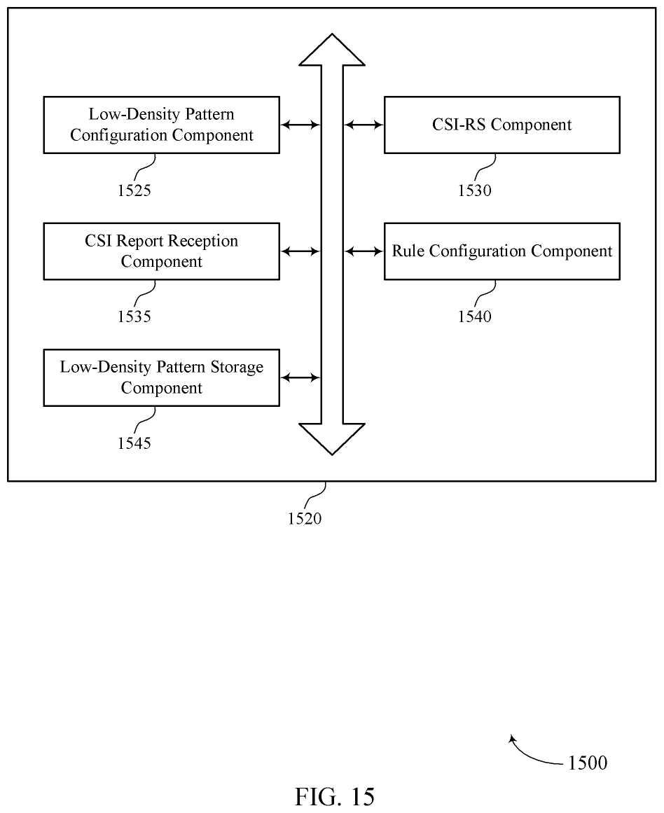

FIG. 15 shows a block diagram 1500 of a communications manager 1520 that supports reference signal pattern association for channel estimation in accordance with one or more aspects of the present disclosure. The communications manager 1520 may be an example of aspects of a communications manager 1320, a communications manager 1420, or both, as described herein. The communications manager 1520, or various components thereof, may be an example of means for performing various aspects of reference signal pattern association for channel estimation as described herein. For example, the communications manager 1520 may include a low-density pattern configuration component 1525, a CSI-RS component 1530, a CSI report reception component 1535, a rule configuration component 1540, a low-density pattern storage component 1545, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1520 may support wireless communications at a network entity in accordance with examples as disclosed herein. The low-density pattern configuration component 1525 may be configured as or otherwise support a means for outputting a control signal configuring a low-density pattern for CSI-RS reception at a UE for a set of multiple antenna ports, where the low-density pattern indicates a subset of the set of multiple antenna ports for the CSI-RS reception via one or more RBs. The CSI-RS component 1530 may be configured as or otherwise support a means for outputting a set of multiple CSI-RSs in accordance with the low-density pattern. The CSI report reception component 1535 may be configured as or otherwise support a means for obtaining a CSI report based on the set of multiple CSI-RSs.

In some examples, the control signal includes a bit map that indicates the low-density pattern for the CSI-RS reception.

In some examples, the control signal includes a first control signal and indicates a first quantity of the subset of the set of multiple antenna ports and a second quantity of the set of multiple antenna ports, and the rule configuration component 1540 may be configured as or otherwise support a means for outputting a second control signal configuring a rule, a lookup table, or both for mapping from a value pair of the first quantity of the subset of the set of multiple antenna ports and the second quantity of the set of multiple antenna ports to the low-density pattern.

In some examples, the low-density pattern storage component 1545 may be configured as or otherwise support a means for storing a set of multiple low-density patterns, where the control signal includes an index value indicating the low-density pattern from the set of multiple low-density patterns.

In some examples, the control signal further includes assistance information that indicates an antenna configuration corresponding to the set of multiple antenna ports, a channel type, environmental information, transmission correlation information, or a combination thereof. In some examples, the CSI report is further based on the assistance information.

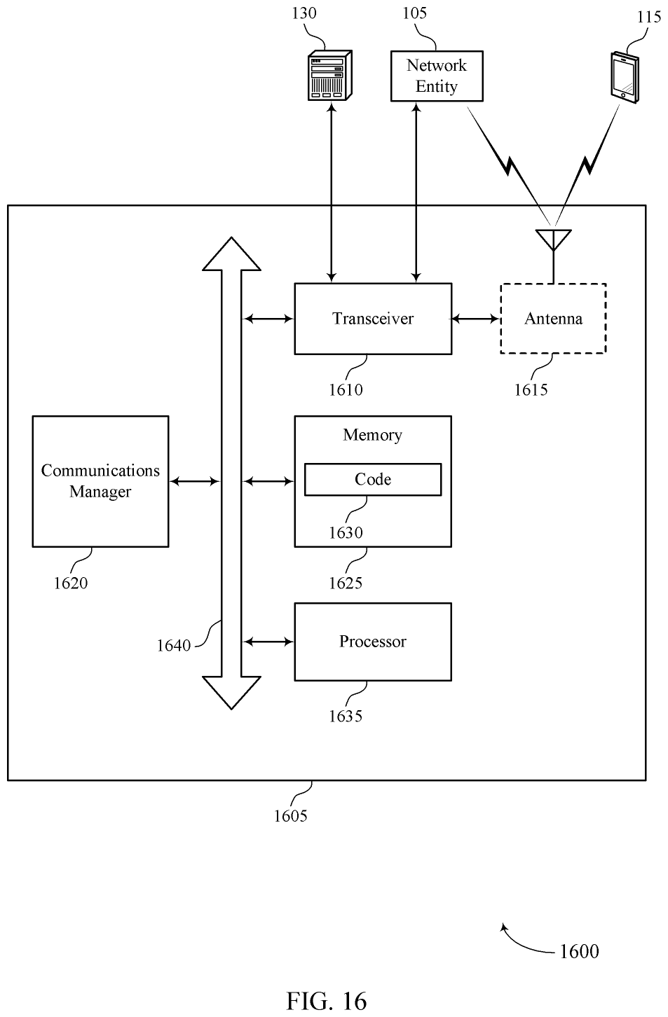

FIG. 16 shows a diagram of a system 1600 including a device 1605 that supports reference signal pattern association for channel estimation in accordance with one or more aspects of the present disclosure. The device 1605 may be an example of or include the components of a device 1305, a device 1405, or a network entity 105 as described herein. The device 1605 may communicate with one or more network entities 105, one or more UEs 115, or any combination thereof, which may include communications over one or more wired interfaces, over one or more wireless interfaces, or any combination thereof. The device 1605 may include components that support outputting and obtaining communications, such as a communications manager 1620, a transceiver 1610, an antenna 1615, a memory 1625, code 1630, and a processor 1635. These components may be in electronic communication or otherwise coupled (e.g., operatively, communicatively, functionally, electronically, electrically) via one or more buses (e.g., a bus 1640).

The transceiver 1610 may support bi-directional communications via wired links, wireless links, or both as described herein. In some examples, the transceiver 1610 may include a wired transceiver and may communicate bi-directionally with another wired transceiver. Additionally, or alternatively, in some examples, the transceiver 1610 may include a wireless transceiver and may communicate bi-directionally with another wireless transceiver. In some examples, the device 1605 may include one or more antennas 1615, which may be capable of transmitting or receiving wireless transmissions (e.g., concurrently). The transceiver 1610 may also include a modem to modulate signals, to provide the modulated signals for transmission (e.g., by one or more antennas 1615, by a wired transmitter), to receive modulated signals (e.g., from one or more antennas 1615, from a wired receiver), and to demodulate signals. In some implementations, the transceiver 1610 may include one or more interfaces, such as one or more interfaces coupled with the one or more antennas 1615 that are configured to support various receiving or obtaining operations, or one or more interfaces coupled with the one or more antennas 1615 that are configured to support various transmitting or outputting operations, or a combination thereof. In some implementations, the transceiver 1610 may include or be configured for coupling with one or more processors or memory components that are operable to perform or support operations based on received or obtained information or signals, or to generate information or other signals for transmission or other outputting, or any combination thereof. In some implementations, the transceiver 1610, or the transceiver 1610 and the one or more antennas 1615, or the transceiver 1610 and the one or more antennas 1615 and one or more processors or memory components (for example, the processor 1635, or the memory 1625, or both), may be included in a chip or chip assembly that is installed in the device 1605. In some examples, the transceiver may be operable to support communications via one or more communications links (e.g., a communication link 125, a backhaul communication link 120, a midhaul communication link 162, a fronthaul communication link 168).

The memory 1625 may include RAM and ROM. The memory 1625 may store computer-readable, computer-executable code 1630 including instructions that, when executed by the processor 1635, cause the device 1605 to perform various functions described herein. The code 1630 may be stored in a non-transitory computer-readable medium such as system memory or another type of memory. In some cases, the code 1630 may not be directly executable by the processor 1635 but may cause a computer (e.g., when compiled and executed) to perform functions described herein. In some cases, the memory 1625 may contain, among other things, a BIOS which may control basic hardware or software operation such as the interaction with peripheral components or devices.

The processor 1635 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1635 may be configured to operate a memory array using a memory controller. In some other cases, a memory controller may be integrated into the processor 1635. The processor 1635 may be configured to execute computer-readable instructions stored in a memory (e.g., the memory 1625) to cause the device 1605 to perform various functions (e.g., functions or tasks supporting reference signal pattern association for channel estimation). For example, the device 1605 or a component of the device 1605 may include a processor 1635 and memory 1625 coupled with the processor 1635, the processor 1635 and memory 1625 configured to perform various functions described herein. The processor 1635 may be an example of a cloud-computing platform (e.g., one or more physical nodes and supporting software such as operating systems, virtual machines, or container instances) that may host the functions (e.g., by executing code 1630) to perform the functions of the device 1605. The processor 1635 may be any one or more suitable processors capable of executing scripts or instructions of one or more software programs stored in the device 1605 (such as within the memory 1625). In some implementations, the processor 1635 may be a component of a processing system. A processing system may refer to a system or series of machines or components that receives inputs and processes the inputs to produce a set of outputs (which may be passed to other systems or components of, for example, the device 1605). For example, a processing system of the device 1605 may refer to a system including the various other components or subcomponents of the device 1605, such as the processor 1635, or the transceiver 1610, or the communications manager 1620, or other components or combinations of components of the device 1605. The processing system of the device 1605 may interface with other components of the device 1605 and may process information received from other components (such as inputs or signals) or output information to other components. For example, a chip or modem of the device 1605 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1605 may transmit information output from the chip or modem. Additionally, or alternatively, in some implementations, the one or more interfaces may refer to an interface between the processing system of the chip or modem and a receiver, such that the device 1605 may obtain information or signal inputs, and the information may be passed to the processing system. A person having ordinary skill in the art will readily recognize that a first interface also may obtain information or signal inputs, and a second interface also may output information or signal outputs.

In some examples, a bus 1640 may support communications of (e.g., within) a protocol layer of a protocol stack. In some examples, a bus 1640 may support communications associated with a logical channel of a protocol stack (e.g., between protocol layers of a protocol stack), which may include communications performed within a component of the device 1605, or between different components of the device 1605 that may be co-located or located in different locations (e.g., where the device 1605 may refer to a system in which one or more of the communications manager 1620, the transceiver 1610, the memory 1625, the code 1630, and the processor 1635 may be located in one of the different components or divided between different components).

In some examples, the communications manager 1620 may manage aspects of communications with a core network 130 (e.g., via one or more wired or wireless backhaul links). For example, the communications manager 1620 may manage the transfer of data communications for client devices, such as one or more UEs 115. In some examples, the communications manager 1620 may manage communications with other network entities 105 and may include a controller or scheduler for controlling communications with UEs 115 in cooperation with other network entities 105. In some examples, the communications manager 1620 may support an X2 interface within an LTE/LTE-A wireless communications network technology to provide communication between network entities 105.

The communications manager 1620 may support wireless communications at a network entity in accordance with examples as disclosed herein. For example, the communications manager 1620 may be configured as or otherwise support a means for outputting a control signal configuring a low-density pattern for CSI-RS signal reception at a UE for a set of multiple antenna ports, where the low-density pattern indicates a subset of the set of multiple antenna ports for the CSI-RS reception via one or more RBs. The communications manager 1620 may be configured as or otherwise support a means for outputting a set of multiple CSI-RSs in accordance with the low-density pattern. The communications manager 1620 may be configured as or otherwise support a means for obtaining a CSI report based on the set of multiple CSI-RSs.

By including or configuring the communications manager 1620 in accordance with examples as described herein, the device 1605 may support techniques for reduced processing overhead and reduced channel overhead associated with CSI-RS transmission. For example, the device 1605 may support transmitting a reduced set of CSI-RSs according to a low-density pattern.

In some examples, the communications manager 1620 may be configured to perform various operations (e.g., receiving, obtaining, monitoring, outputting, transmitting) using or otherwise in cooperation with the transceiver 1610, the one or more antennas 1615 (e.g., where applicable), or any combination thereof. Although the communications manager 1620 is illustrated as a separate component, in some examples, one or more functions described with reference to the communications manager 1620 may be supported by or performed by the transceiver 1610, the processor 1635, the memory 1625, the code 1630, or any combination thereof. For example, the code 1630 may include instructions executable by the processor 1635 to cause the device 1605 to perform various aspects of reference signal pattern association for channel estimation as described herein, or the processor 1635 and the memory 1625 may be otherwise configured to perform or support such operations.

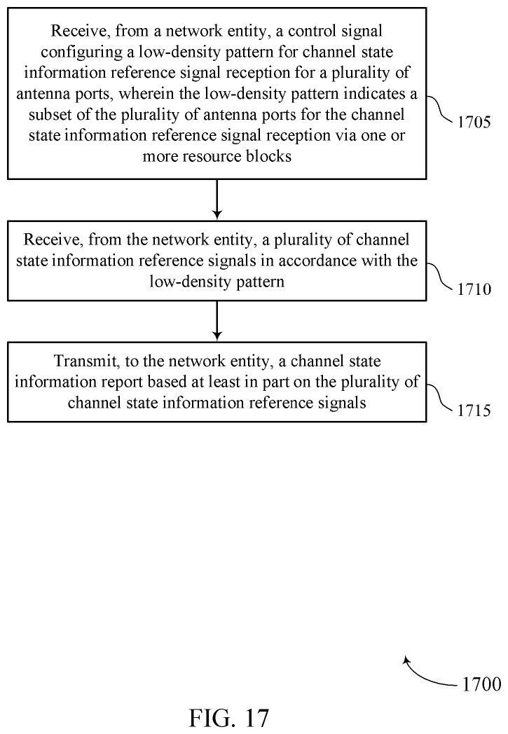

FIG. 17 shows a flowchart illustrating a method 1700 that supports reference signal pattern association for channel estimation in accordance with one or more aspects of the present disclosure. The operations of the method 1700 may be implemented by a UE or its components as described herein. For example, the operations of the method 1700 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1705, the method may include receiving, from a network entity, a control signal configuring a low-density pattern for CSI-RS reception for a set of multiple antenna ports, where the low-density pattern indicates a subset of the set of multiple antenna ports for the CSI-RS reception via one or more RBs. The operations of 1705 may be performed in accordance with examples as disclosed herein. In some examples, aspects of the operations of 1705 may be performed by a low-density pattern configuration component 1125 as described with reference to FIG. 11.

At 1710, the method may include receiving, from the network entity, a set of multiple CSI-RS in accordance with the low-density pattern. The operations of 1710 may be performed in accordance with examples as disclosed herein. In some examples, aspects of the operations of 1710 may be performed by a CSI-RS reception component 1130 as described with reference to FIG. 11.

At 1715, the method may include transmitting, to the network entity, a CSI report based on the set of multiple CSI-RSs. The operations of 1715 may be performed in accordance with examples as disclosed herein. In some examples, aspects of the operations of 1715 may be performed by a CSI reporting component 1135 as described with reference to FIG. 11.

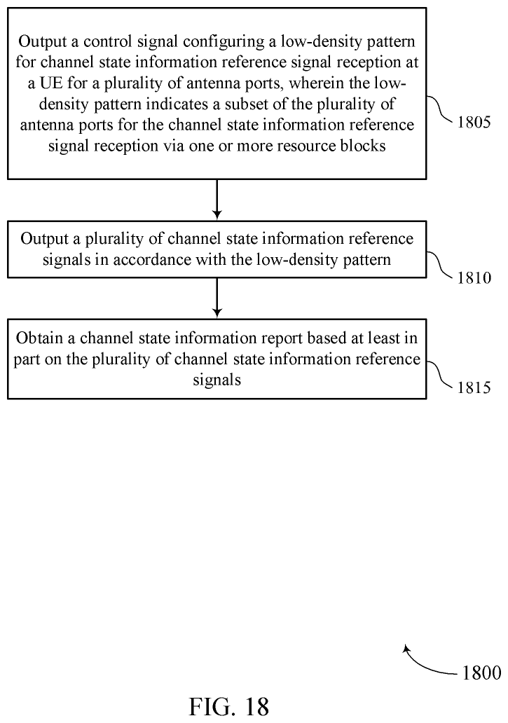

FIG. 18 shows a flowchart illustrating a method 1800 that supports reference signal pattern association for channel estimation in accordance with one or more aspects of the present disclosure. The operations of the method 1800 may be implemented by a network entity or its components as described herein. For example, the operations of the method 1800 may be performed by a network entity as described with reference to FIGS. 1 through 8 and 13 through 16. In some examples, a network entity may execute a set of instructions to control the functional elements of the network entity to perform the described functions. Additionally, or alternatively, the network entity may perform aspects of the described functions using special-purpose hardware.

At 1805, the method may include outputting a control signal configuring a low-density pattern for CSI-RS reception at a UE for a set of multiple antenna ports, where the low-density pattern indicates a subset of the set of multiple antenna ports for the CSI-RS reception via one or more RBs. The operations of 1805 may be performed in accordance with examples as disclosed herein. In some examples, aspects of the operations of 1805 may be performed by a low-density pattern configuration component 1525 as described with reference to FIG. 15.

At 1810, the method may include outputting a set of multiple CSI-RSs in accordance with the low-density pattern. The operations of 1810 may be performed in accordance with examples as disclosed herein. In some examples, aspects of the operations of 1810 may be performed by a CSI-RS component 1530 as described with reference to FIG. 15.

At 1815, the method may include obtaining a CSI report based on the set of multiple CSI-RSs. The operations of 1815 may be performed in accordance with examples as disclosed herein. In some examples, aspects of the operations of 1815 may be performed by a CSI report reception component 1535 as described with reference to FIG. 15.

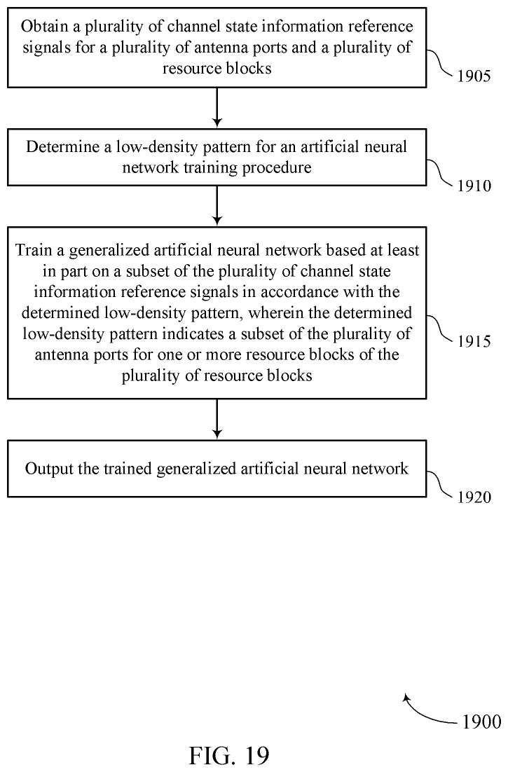

FIG. 19 shows a flowchart illustrating a method 1900 that supports reference signal pattern association for channel estimation in accordance with one or more aspects of the present disclosure. The operations of the method 1900 may be implemented by a device (e.g., a neural network training device, a UE 115) or its components as described herein. For example, the operations of the method 1900 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1905, the method may include obtaining a set of multiple CSI-RSs for a set of multiple antenna ports and a set of multiple RBs. The operations of 1905 may be performed in accordance with examples as disclosed herein. In some examples, aspects of the operations of 1905 may be performed by a CSI-RS reception component 1130 as described with reference to FIG. 11.

At 1910, the method may include determining a low-density pattern for an artificial neural network training procedure. The operations of 1910 may be performed in accordance with examples as disclosed herein. In some examples, aspects of the operations of 1910 may be performed by a low-density pattern determination component 1140 as described with reference to FIG. 11.

At 1915, the method may include training a generalized artificial neural network based on a subset of the set of multiple CSI-RSs in accordance with the determined low-density pattern, where the determined low-density pattern indicates a subset of the set of multiple antenna ports for one or more RBs of the set of multiple RBs. The operations of 1915 may be performed in accordance with examples as disclosed herein. In some examples, aspects of the operations of 1915 may be performed by a neural network training component 1145 as described with reference to FIG. 11.

At 1920, the method may include outputting the trained generalized artificial neural network. The operations of 1920 may be performed in accordance with examples as disclosed herein. In some examples, aspects of the operations of 1920 may be performed by a neural network output component 1150 as described with reference to FIG. 11.

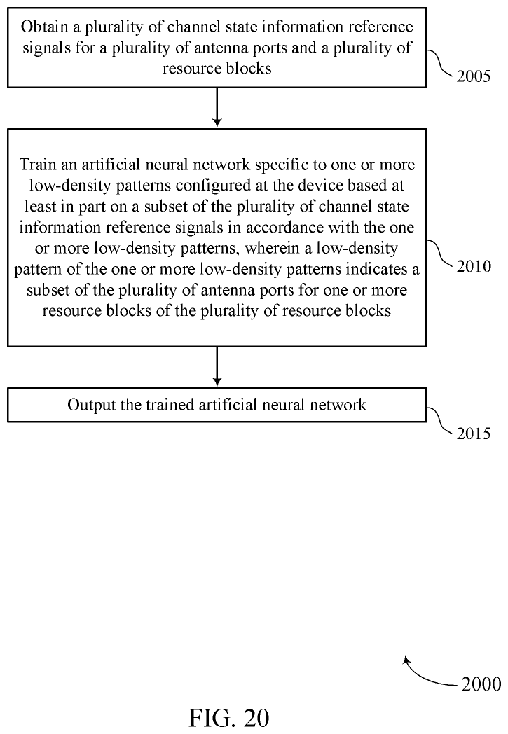

FIG. 20 shows a flowchart illustrating a method 2000 that supports reference signal pattern association for channel estimation in accordance with one or more aspects of the present disclosure. The operations of the method 2000 may be implemented by a device (e.g., a neural network training device, a UE 115) or its components as described herein. For example, the operations of the method 2000 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 2005, the method may include obtaining a set of multiple CSI-RSs for a set of multiple antenna ports and a set of multiple RBs. The operations of 2005 may be performed in accordance with examples as disclosed herein. In some examples, aspects of the operations of 2005 may be performed by a CSI-RS reception component 1130 as described with reference to FIG. 11.

At 2010, the method may include training an artificial neural network specific to one or more low-density patterns configured at the device based on a subset of the set of multiple CSI-RSs in accordance with the one or more low-density patterns, where a low-density pattern of the one or more low-density patterns indicates a subset of the set of multiple antenna ports for one or more RBs of the set of multiple RBs. The operations of 2010 may be performed in accordance with examples as disclosed herein. In some examples, aspects of the operations of 2010 may be performed by a neural network training component 1145 as described with reference to FIG. 11.

At 2015, the method may include outputting the trained artificial neural network. The operations of 2015 may be performed in accordance with examples as disclosed herein. In some examples, aspects of the operations of 2015 may be performed by a neural network output component 1150 as described with reference to FIG. 11.

The following provides an overview of aspects of the present disclosure:

Aspect 1: An apparatus for wireless communications at a UE, comprising: a processor; and memory coupled with the processor, the processor configured to: receive, from a network entity, a control signal that configures a low-density pattern for channel state information reference signal reception for a plurality of antenna ports, wherein the low-density pattern indicates a subset of the plurality of antenna ports for the channel state information reference signal reception via one or more resource blocks; receive, from the network entity, a plurality of channel state information reference signals in accordance with the low-density pattern; and transmit, to the network entity, a channel state information report based at least in part on the plurality of channel state information reference signals.

Aspect 2: The apparatus of aspect 1, wherein the processor is further configured to: determine the low-density pattern based at least in part on the control signal that indicates a mapping from the subset of the plurality of antenna ports to the plurality of antenna ports for the one or more resource blocks.

Aspect 3: The apparatus of aspect 2, wherein the mapping is specific to a resource block, is specific to a resource block group, or is common to a plurality of resource blocks in a frequency band that corresponds to the channel state information reference signal reception.

Aspect 4: The apparatus of any of aspects 1 through 3, wherein the processor is further configured to: determine the low-density pattern based at least in part on the control signal that indicates a resource block muting pattern for one or more antenna ports of the plurality of antenna ports.

Aspect 5: The apparatus of aspect 4, wherein the resource block muting pattern is specific to an antenna port of the plurality of antenna ports, is specific to a group of antenna ports of the plurality of antenna ports, or is common to the plurality of antenna ports.

Aspect 6: The apparatus of any of aspects 1 through 3, wherein the processor is further configured to: determine the low-density pattern based at least in part on the control signal that indicates an antenna port muting pattern for the one or more resource blocks.

Aspect 7: The apparatus of aspect 6, wherein the antenna port muting pattern is specific to a resource block, is specific to a resource block group, or is common to a plurality of resource blocks in a frequency band that corresponds to the channel state information reference signal reception.

Aspect 8: The apparatus of any of aspects 1 through 3, wherein the processor is further configured to: determine the low-density pattern based at least in part on the control signal that indicates a cover code that configures a plurality of antenna port-resource block pairs to use for the channel state information reference signal reception.

Aspect 9: The apparatus of any of aspects 1 through 8, wherein the processor is further configured to: determine a channel state information measurement based at least in part on an artificial neural network and the plurality of channel state information reference signals received in accordance with the low-density pattern, wherein the channel state information report comprises the channel state information measurement.

Aspect 10: The apparatus of aspect 9, wherein the processor is further configured to: zero-pad the received plurality of channel state information reference signals based at least in part on the low-density pattern; and input the zero-padded received plurality of channel state information reference signals into the artificial neural network, wherein the channel state information measurement is determined based at least in part on an output of the artificial neural network.

Aspect 11: The apparatus of any of aspects 9 through 10, wherein the processor is further configured to: train the artificial neural network based at least in part on the low-density pattern.

Aspect 12: The apparatus of any of aspects 1 through 11, wherein the control signal comprises a bit map that indicates the low-density pattern for the channel state information reference signal reception.

Aspect 13: The apparatus of any of aspects 1 through 11, wherein the control signal indicates a first quantity of the subset of the plurality of antenna ports and a second quantity of the plurality of antenna ports, and the processor is further configured to: determine the low-density pattern for the channel state information reference signal reception based at least in part on the first quantity, the second quantity, and a rule, a lookup table, or both for mapping from the first quantity and the second quantity to the low-density pattern.

Aspect 14: The apparatus of any of aspects 1 through 3 and 9 through 11, wherein the processor is further configured to: store a plurality of low-density patterns, wherein the control signal comprises an index value that indicates the low-density pattern from the plurality of low-density patterns.

Aspect 15: The apparatus of any of aspects 1 through 14, wherein: the control signal further comprises assistance information that indicates an antenna configuration corresponding to the plurality of antenna ports, a channel type, environmental information, transmission correlation information, or a combination thereof; and the channel state information report is further based at least in part on the assistance information.

Aspect 16: An apparatus for wireless communications at a network entity, comprising: a processor; and memory coupled with the processor, the processor configured to: output a control signal that configures a low-density pattern for channel state information reference signal reception at a UE for a plurality of antenna ports, wherein the low-density pattern indicates a subset of the plurality of antenna ports for the channel state information reference signal reception via one or more resource blocks; output a plurality of channel state information reference signals in accordance with the low-density pattern; and obtain a channel state information report based at least in part on the plurality of channel state information reference signals.

Aspect 17: The apparatus of aspect 16, wherein the control signal comprises a bit map that indicates the low-density pattern for the channel state information reference signal reception.

Aspect 18: The apparatus of aspect 16, wherein the control signal comprises a first control signal and indicates a first quantity of the subset of the plurality of antenna ports and a second quantity of the plurality of antenna ports, and the processor is further configured to: output a second control signal configuring a rule, a lookup table, or both for mapping from a value pair of the first quantity of the subset of the plurality of antenna ports and the second quantity of the plurality of antenna ports to the low-density pattern.

Aspect 19: The apparatus of aspect 16, wherein the processor is further configured to: store a plurality of low-density patterns, wherein the control signal comprises an index value that indicates the low-density pattern from the plurality of low-density patterns.

Aspect 20: The apparatus of any of aspects 16 through 19, wherein: the control signal further comprises assistance information that indicates an antenna configuration corresponding to the plurality of antenna ports, a channel type, environmental information, transmission correlation information, or a combination thereof; and the channel state information report is further based at least in part on the assistance information.

Aspect 21: An apparatus for wireless communications at a device, comprising: a processor; and memory coupled with the processor, the processor configured to: obtain a plurality of channel state information reference signals for a plurality of antenna ports and a plurality of resource blocks; determine a low-density pattern for an artificial neural network training procedure; train a generalized artificial neural network based at least in part on a subset of the plurality of channel state information reference signals in accordance with the determined low-density pattern, wherein the determined low-density pattern indicates a subset of the plurality of antenna ports for one or more resource blocks of the plurality of resource blocks; and output the trained generalized artificial neural network.

Aspect 22: The apparatus of aspect 21, wherein the processor is further configured to: determine one or more additional low-density patterns for the artificial neural network training procedure; and further train the generalized artificial neural network based at least in part on the one or more additional low-density patterns.

Aspect 23: The apparatus of any of aspects 21 through 22, wherein the processor is further configured to: randomly select one or more low-density patterns, wherein the low-density pattern is determined based at least in part on the random selection.

Aspect 24: The apparatus of any of aspects 21 through 23, wherein the determined low-density pattern indicates a random selection of the subset of the plurality of antenna ports for each resource block of the plurality of resource blocks.

Aspect 25: The apparatus of any of aspects 21 through 23, wherein: the determined low-density pattern indicates a random selection of the subset of the plurality of antenna ports for a first set of resource blocks of the plurality of resource blocks; and a selection of the subset of the plurality of antenna ports for a second set of resource blocks of the plurality of resource blocks is based at least in part on the random selection of the subset of the plurality of antenna ports for the first set of resource blocks.

Aspect 26: An apparatus for wireless communications at a device, comprising: a processor; and memory coupled with the processor, the processor configured to: obtain a plurality of channel state information reference signals for a plurality of antenna ports and a plurality of resource blocks; train an artificial neural network specific to one or more low-density patterns configured at the device based at least in part on a subset of the plurality of channel state information reference signals in accordance with the one or more low-density patterns, wherein a low-density pattern of the one or more low-density patterns indicates a subset of the plurality of antenna ports for one or more resource blocks of the plurality of resource blocks; and output the trained artificial neural network.

Aspect 27: The apparatus of aspect 26, wherein the processor is further configured to: obtain a configuration of the one or more low-density patterns, wherein the artificial neural network is trained based at least in part on the configuration.

Aspect 28: The apparatus of any of aspects 26 through 27, wherein the processor is further configured to: store the one or more low-density patterns at the device, wherein the artificial neural network is trained based at least in part on the stored one or more low-density patterns.

Aspect 29: The apparatus of any of aspects 26 through 28, wherein the artificial neural network is specific to a low-density pattern, and the processor is further configured to: train one or more additional artificial neural networks specific to one or more additional low-density patterns configured at the device; and output the one or more additional trained artificial neural networks.

Aspect 30: The apparatus of any of aspects 26 through 29, the processor configured to output the trained artificial neural network is configured to: output the trained artificial neural network with an indication that the trained artificial neural network is specific to the one or more low-density patterns.

Aspect 31: A method for wireless communications at a UE, comprising: receiving, from a network entity, a control signal configuring a low-density pattern for channel state information reference signal reception for a plurality of antenna ports, wherein the low-density pattern indicates a subset of the plurality of antenna ports for the channel state information reference signal reception via one or more resource blocks; receiving, from the network entity, a plurality of channel state information reference signals in accordance with the low-density pattern; and transmitting, to the network entity, a channel state information report based at least in part on the plurality of channel state information reference signals.

Aspect 32: The method of aspect 31, further comprising: determining the low-density pattern based at least in part on the control signal indicating a mapping from the subset of the plurality of antenna ports to the plurality of antenna ports for the one or more resource blocks.

Aspect 33: The method of aspect 32, wherein the mapping is specific to a resource block, is specific to a resource block group, or is common to a plurality of resource blocks in a frequency band corresponding to the channel state information reference signal reception.

Aspect 34: The method of any of aspects 31 through 33, further comprising: determining the low-density pattern based at least in part on the control signal indicating a resource block muting pattern for one or more antenna ports of the plurality of antenna ports.

Aspect 35: The method of aspect 34, wherein the resource block muting pattern is specific to an antenna port of the plurality of antenna ports, is specific to a group of antenna ports of the plurality of antenna ports, or is common to the plurality of antenna ports.

Aspect 36: The method of any of aspects 31 through 33, further comprising: determining the low-density pattern based at least in part on the control signal indicating an antenna port muting pattern for the one or more resource blocks.

Aspect 37: The method of aspect 36, wherein the antenna port muting pattern is specific to a resource block, is specific to a resource block group, or is common to a plurality of resource blocks in a frequency band corresponding to the channel state information reference signal reception.

Aspect 38: The method of any of aspects 31 through 33, further comprising: determining the low-density pattern based at least in part on the control signal indicating a cover code that configures a plurality of antenna port-resource block pairs to use for the channel state information reference signal reception.

Aspect 39: The method of any of aspects 31 through 38, further comprising: determining a channel state information measurement based at least in part on an artificial neural network and the plurality of channel state information reference signals received in accordance with the low-density pattern, wherein the channel state information report comprises the channel state information measurement.

Aspect 40: The method of aspect 39, further comprising: zero-padding the received plurality of channel state information reference signals based at least in part on the low-density pattern; and inputting the zero-padded received plurality of channel state information reference signals into the artificial neural network, wherein the channel state information measurement is determined based at least in part on an output of the artificial neural network.

Aspect 41: The method of any of aspects 39 through 40, further comprising: training the artificial neural network based at least in part on the low-density pattern.

Aspect 42: The method of any of aspects 31 through 41, wherein the control signal comprises a bit map that indicates the low-density pattern for the channel state information reference signal reception.

Aspect 43: The method of any of aspects 31 through 41, wherein the control signal indicates a first quantity of the subset of the plurality of antenna ports and a second quantity of the plurality of antenna ports, the method further comprising: determining the low-density pattern for the channel state information reference signal reception based at least in part on the first quantity, the second quantity, and a rule, a lookup table, or both for mapping from the first quantity and the second quantity to the low-density pattern.

Aspect 44: The method of any of aspects 31 through 33 and 39 through 41, further comprising: storing a plurality of low-density patterns, wherein the control signal comprises an index value indicating the low-density pattern from the plurality of low-density patterns.

Aspect 45: The method of any of aspects 31 through 44, wherein: the control signal further comprises assistance information that indicates an antenna configuration corresponding to the plurality of antenna ports, a channel type, environmental information, transmission correlation information, or a combination thereof; and the channel state information report is further based at least in part on the assistance information.

Aspect 46: A method for wireless communications at a network entity, comprising: outputting a control signal configuring a low-density pattern for channel state information reference signal reception at a UE for a plurality of antenna ports, wherein the low-density pattern indicates a subset of the plurality of antenna ports for the channel state information reference signal reception via one or more resource blocks; outputting a plurality of channel state information reference signals in accordance with the low-density pattern; and obtaining a channel state information report based at least in part on the plurality of channel state information reference signals.

Aspect 47: The method of aspect 46, wherein the control signal comprises a bit map that indicates the low-density pattern for the channel state information reference signal reception.

Aspect 48: The method of aspect 46, wherein the control signal comprises a first control signal and indicates a first quantity of the subset of the plurality of antenna ports and a second quantity of the plurality of antenna ports, the method further comprising: outputting a second control signal configuring a rule, a lookup table, or both for mapping from a value pair of the first quantity of the subset of the plurality of antenna ports and the second quantity of the plurality of antenna ports to the low-density pattern.

Aspect 49: The method of aspect 46, further comprising: storing a plurality of low-density patterns, wherein the control signal comprises an index value indicating the low-density pattern from the plurality of low-density patterns.

Aspect 50: The method of any of aspects 46 through 49, wherein the control signal further comprises: assistance information that indicates an antenna configuration corresponding to the plurality of antenna ports, a channel type, environmental information, transmission correlation information, or a combination thereof; and the channel state information report is further based at least in part on the assistance information.

Aspect 51: A method for wireless communications at a device, comprising: obtaining a plurality of channel state information reference signals for a plurality of antenna ports and a plurality of resource blocks; determining a low-density pattern for an artificial neural network training procedure; training a generalized artificial neural network based at least in part on a subset of the plurality of channel state information reference signals in accordance with the determined low-density pattern, wherein the determined low-density pattern indicates a subset of the plurality of antenna ports for one or more resource blocks of the plurality of resource blocks; and outputting the trained generalized artificial neural network.

Aspect 52: The method of aspect 51, further comprising: determining one or more additional low-density patterns for the artificial neural network training procedure; and further training the generalized artificial neural network based at least in part on the one or more additional low-density patterns.

Aspect 53: The method of any of aspects 51 through 52, further comprising: randomly selecting one or more low-density patterns, wherein the low-density pattern is determined based at least in part on the random selection.

Aspect 54: The method of any of aspects 51 through 53, wherein the determined low-density pattern indicates a random selection of the subset of the plurality of antenna ports for each resource block of the plurality of resource blocks.

Aspect 55: The method of any of aspects 51 through 53, wherein: the determined low-density pattern indicates a random selection of the subset of the plurality of antenna ports for a first set of resource blocks of the plurality of resource blocks; and a selection of the subset of the plurality of antenna ports for a second set of resource blocks of the plurality of resource blocks is based at least in part on the random selection of the subset of the plurality of antenna ports for the first set of resource blocks.

Aspect 56: A method for wireless communications at a device, comprising: obtaining a plurality of channel state information reference signals for a plurality of antenna ports and a plurality of resource blocks; training an artificial neural network specific to one or more low-density patterns configured at the device based at least in part on a subset of the plurality of channel state information reference signals in accordance with the one or more low-density patterns, wherein a low-density pattern of the one or more low-density patterns indicates a subset of the plurality of antenna ports for one or more resource blocks of the plurality of resource blocks; and outputting the trained artificial neural network.

Aspect 57: The method of aspect 56, further comprising: obtaining a configuration of the one or more low-density patterns, wherein the artificial neural network is trained based at least in part on the configuration.

Aspect 58: The method of any of aspects 56 through 57, further comprising: storing the one or more low-density patterns at the device, wherein the artificial neural network is trained based at least in part on the stored one or more low-density patterns.

Aspect 59: The method of any of aspects 56 through 58, wherein the artificial neural network is specific to a low-density pattern, the method further comprising: training one or more additional artificial neural networks specific to one or more additional low-density patterns configured at the device; and outputting the one or more additional trained artificial neural networks.

Aspect 60: The method of any of aspects 56 through 59, wherein the outputting the trained artificial neural network further comprises: outputting the trained artificial neural network with an indication that the trained artificial neural network is specific to the one or more low-density patterns.

Aspect 61: An apparatus for wireless communications at a UE, comprising at least one means for performing a method of any of aspects 31 through 45.

Aspect 62: A non-transitory computer-readable medium storing code for wireless communications at a UE, the code comprising instructions executable by a processor to perform a method of any of aspects 31 through 45.

Aspect 63: An apparatus for wireless communications at a network entity, comprising at least one means for performing a method of any of aspects 46 through 50.

Aspect 64: A non-transitory computer-readable medium storing code for wireless communications at a network entity, the code comprising instructions executable by a processor to perform a method of any of aspects 46 through 50.

Aspect 65: An apparatus for wireless communications at a device, comprising at least one means for performing a method of any of aspects 51 through 55.

Aspect 66: A non-transitory computer-readable medium storing code for wireless communications at a device, the code comprising instructions executable by a processor to perform a method of any of aspects 51 through 55.

Aspect 67: An apparatus for wireless communications at a device, comprising at least one means for performing a method of any of aspects 56 through 60.

Aspect 68: A non-transitory computer-readable medium storing code for wireless communications at a device, the code comprising instructions executable by a processor to perform a method of any of aspects 56 through 60.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communications at a user equipment (UE), comprising:
a processor; and
memory coupled with the processor, the processor configured to:
receive, from a network entity, a control signal that configures a low-density pattern for channel state information reference signal reception for a plurality of antenna ports, wherein the low-density pattern indicates a subset of the plurality of antenna ports for the channel state information reference signal reception via one or more resource blocks;
receive, from the network entity, a plurality of channel state information reference signals in accordance with the low-density pattern; and
transmit, to the network entity, a channel state information report based at least in part on the plurality of channel state information reference signals.

2. The apparatus of claim 1, wherein the processor is further configured to:
determine the low-density pattern based at least in part on the control signal that indicates a mapping from the subset of the plurality of antenna ports to the plurality of antenna ports for the one or more resource blocks.

3. The apparatus of claim 2, wherein the mapping is specific to a resource block, is specific to a resource block group, or is common to a plurality of resource blocks in a frequency band that corresponds to the channel state information reference signal reception.

4. The apparatus of claim 1, wherein the processor is further configured to:
determine the low-density pattern based at least in part on the control signal that indicates a resource block muting pattern for one or more antenna ports of the plurality of antenna ports.

5. The apparatus of claim 4, wherein the resource block muting pattern is specific to an antenna port of the plurality of antenna ports, is specific to a group of antenna ports of the plurality of antenna ports, or is common to the plurality of antenna ports.

6. The apparatus of claim 1, wherein the processor is further configured to:
determine the low-density pattern based at least in part on the control signal that indicates an antenna port muting pattern for the one or more resource blocks.

7. The apparatus of claim 6, wherein the antenna port muting pattern is specific to a resource block, is specific to a resource block group, or is common to a plurality of resource blocks in a frequency band that corresponds to the channel state information reference signal reception.

8. The apparatus of claim 1, wherein the processor is further configured to:
determine the low-density pattern based at least in part on the control signal that indicates a cover code that configures a plurality of antenna port-resource block pairs to use for the channel state information reference signal reception.

9. The apparatus of claim 1, wherein the processor is further configured to:
determine a channel state information measurement based at least in part on an artificial neural network and the plurality of channel state information reference signals received in accordance with the low-density pattern, wherein the channel state information report comprises the channel state information measurement.

10. The apparatus of claim 9, wherein the processor is further configured to:
zero-pad the received plurality of channel state information reference signals based at least in part on the low-density pattern; and
input the zero-padded received plurality of channel state information reference signals into the artificial neural network, wherein the channel state information measurement is determined based at least in part on an output of the artificial neural network.

11. The apparatus of claim 9, wherein the processor is further configured to:
train the artificial neural network based at least in part on the low-density pattern.

12. The apparatus of claim 1, wherein the control signal comprises a bit map that indicates the low-density pattern for the channel state information reference signal reception.

13. The apparatus of claim 1, wherein the control signal indicates a first quantity of the subset of the plurality of antenna ports and a second quantity of the plurality of antenna ports, and the processor is further configured to:
determine the low-density pattern for the channel state information reference signal reception based at least in part on the first quantity, the second quantity, and a rule, a lookup table, or both for mapping from the first quantity and the second quantity to the low-density pattern.

14. The apparatus of claim 1, wherein the processor is further configured to:
store a plurality of low-density patterns, wherein the control signal comprises an index value that indicates the low-density pattern from the plurality of low-density patterns.

15. The apparatus of claim 1, wherein:
the control signal further comprises assistance information that indicates an antenna configuration corresponding to the plurality of antenna ports, a channel type, environmental information, transmission correlation information, or a combination thereof; and
the channel state information report is further based at least in part on the assistance information.

16. An apparatus for wireless communications at a network entity, comprising:
a processor; and
memory coupled with the processor, the processor configured to:
output a control signal that configures a low-density pattern for channel state information reference signal reception at a user equipment (UE) for a plurality of antenna ports, wherein the low-density pattern indicates a subset of the plurality of antenna ports for the channel state information reference signal reception via one or more resource blocks;
output a plurality of channel state information reference signals in accordance with the low-density pattern; and
obtain a channel state information report based at least in part on the plurality of channel state information reference signals.

17. The apparatus of claim 16, wherein the control signal comprises a bit map that indicates the low-density pattern for the channel state information reference signal reception.

18. The apparatus of claim 16, wherein the control signal comprises a first control signal and indicates a first quantity of the subset of the plurality of antenna ports and a second quantity of the plurality of antenna ports, and the processor is further configured to:
output a second control signal configuring a rule, a lookup table, or both for mapping from a value pair of the first quantity of the subset of the plurality of antenna ports and the second quantity of the plurality of antenna ports to the low-density pattern.

19. The apparatus of claim 16, wherein the processor is further configured to:
store a plurality of low-density patterns, wherein the control signal comprises an index value that indicates the low-density pattern from the plurality of low-density patterns.

20. The apparatus of claim 16, wherein:
the control signal further comprises assistance information that indicates an antenna configuration corresponding to the plurality of antenna ports, a channel type, environmental information, transmission correlation information, or a combination thereof; and
the channel state information report is further based at least in part on the assistance information.

21. An apparatus for wireless communications at a device, comprising:
a processor; and
memory coupled with the processor, the processor configured to:
obtain a plurality of channel state information reference signals for a plurality of antenna ports and a plurality of resource blocks;
determine a low-density pattern for an artificial neural network training procedure;
train a generalized artificial neural network based at least in part on a subset of the plurality of channel state information reference signals in accordance with the determined low-density pattern, wherein the determined low-density pattern indicates a subset of the plurality of antenna ports for one or more resource blocks of the plurality of resource blocks; and
output the trained generalized artificial neural network.

22. The apparatus of claim 21, wherein the processor is further configured to:
determine one or more additional low-density patterns for the artificial neural network training procedure; and
further train the generalized artificial neural network based at least in part on the one or more additional low-density patterns.

23. The apparatus of claim 21, wherein the processor is further configured to:
randomly select one or more low-density patterns, wherein the low-density pattern is determined based at least in part on the random selection.

24. The apparatus of claim 21, wherein the determined low-density pattern indicates a random selection of the subset of the plurality of antenna ports for each resource block of the plurality of resource blocks.

25. The apparatus of claim 21, wherein:
the determined low-density pattern indicates a random selection of the subset of the plurality of antenna ports for a first set of resource blocks of the plurality of resource blocks; and
a selection of the subset of the plurality of antenna ports for a second set of resource blocks of the plurality of resource blocks is based at least in part on the random selection of the subset of the plurality of antenna ports for the first set of resource blocks.

26. An apparatus for wireless communications at a device, comprising:
a processor; and
memory coupled with the processor, the processor configured to:
obtain a plurality of channel state information reference signals for a plurality of antenna ports and a plurality of resource blocks;
train an artificial neural network specific to one or more low-density patterns configured at the device based at least in part on a subset of the plurality of channel state information reference signals in accordance with the one or more low-density patterns, wherein a low-density pattern of the one or more low-density patterns indicates a subset of the plurality of antenna ports for one or more resource blocks of the plurality of resource blocks; and
output the trained artificial neural network.

27. The apparatus of claim 26, wherein the processor is further configured to:
obtain a configuration of the one or more low-density patterns, wherein the artificial neural network is trained based at least in part on the configuration.

28. The apparatus of claim 26, wherein the processor is further configured to:
store the one or more low-density patterns at the device, wherein the artificial neural network is trained based at least in part on the stored one or more low-density patterns.

29. The apparatus of claim 26, wherein the artificial neural network is specific to a low-density pattern, and the processor is further configured to:
train one or more additional artificial neural networks specific to one or more additional low-density patterns configured at the device; and
output the one or more additional trained artificial neural networks.

30. The apparatus of claim 26, the processor configured to output the trained artificial neural network is configured to:
output the trained artificial neural network with an indication that the trained artificial neural network is specific to the one or more low-density patterns.
